(19) United States
(12) Patent Application Publication
(10) Pub. No.: US 2024/0094439 A1
(43) Pub. Date: Mar. 21, 2024

(54) JONES MATRIX HOLOGRAPHY WITH METASURFACES

(71) Applicant: PRESIDENT AND FELLOWS OF HARVARD COLLEGE, Cambridge, MA (US)

(72) Inventors: Noah A. RUBIN, Cambridge, MA (US); Mohammad Aun Abbas ZAIDI, Cambridge, MA (US); Federico CAPASSO, Cambridge, MA (US)

(73) Assignee: PRESIDENT AND FELLOWS OF HARVARD COLLEGE, Cambridge, MA (US)

(21) Appl. No.: 18/269,939

(22) PCT Filed: Dec. 27, 2021
(86) PCT No.: PCT/US2021/065231

§ 371 Date: Jun. 27, 2023

Related U.S. Application Data
(60) Provisional application No. 63/131,227, filed on Dec. 28, 2020.
(60) Provisional application No. 63/274,445, filed on Nov. 1, 2021.

(51) Int. Cl. G02B 1/08; G02B 5/30; G02B 5/32; G02B 27/28; G02B 27/42

(52) U.S. Cl. CPC G02B 1/08; G02B 5/3083; G02B 5/32; G02B 27/286; G02B 27/4261

(57) ABSTRACT

An optical component can include a substrate. The optical component can include a metasurface disposed on the substrate. The metasurface can include one or more linearly birefringent elements. A spatially-varying Jones matrix and a far-field of the metasurface can define a transfer function of the metasurface configured to generate a controlled response in the far-field according to polarization of light incident on the metasurface.

### CROSS-REFERENCE TO RELATED PATENT APPLICATIONS

This application claims the benefit and priority of U.S. Provisional Patent Application No. 63/131,227, filed on Dec. 28, 2020, and U.S. Provisional Patent Application No. 63/274,445, filed on Nov. 1, 2021, each of which are hereby incorporated by reference in their entirety.

### GOVERNMENT LICENSE RIGHTS

This invention was made with government support under FA9550-19-1-0135 awarded by the Air Force Office of Scientific Research. The government has certain rights in the invention.

### BACKGROUND

A variety of holographic materials and technologies can permit the control of polarization in a spatially-varying fashion.

### SUMMARY

The systems and methods of the present disclosure relate to a class of computer generated holograms whose far fields possess designer-specified polarization response. This class of computer generated holograms can be termed Jones matrix holograms. A procedure for their implementation using form-birefringent metasurfaces is disclosed. Jones matrix holography, as disclosed herein, provides a consistent mathematical framework in the field of metasurfaces and provides previously unrealized devices. For example, the present disclosure demonstrates holograms whose far-fields implement parallel polarization analysis and custom waveplate-like behavior. Additionally, the systems and methods of the present disclosure relate to generalized polarization transformations with metasurfaces. They can be used in applications such as polarization aberration correction in imaging systems and experiments that can use novel and compact polarization detection and control.

At least one aspect of the present disclosure is directed to an optical component. The optical component can include a substrate. The optical component can include a metasurface disposed on the substrate. The metasurface can include one or more linearly birefringent elements. A spatially-varying Jones matrix and a far-field of the metasurface can define a transfer function of the metasurface configured to generate a controlled response in the far-field according to polarization of light incident on the metasurface.

Another aspect of the present disclosure is directed to an optical component. The optical component can include a substrate. The optical component can include a metasurface disposed on the substrate. The metasurface can include one or more linearly birefringent elements. The metasurface can be configured to implement a target polarization transformation on light incident on the metasurface. A far-field of the metasurface can include a target polarization response corresponding to the target polarization transformation.

Another aspect of the present disclosure is directed to an iterative phase retrieval method. The method can produce an optical component. The method can include providing a first Jones matrix. The method can include implementing a Fourier transform of the first Jones matrix to produce a second Jones matrix. The method can include implementing a polar decomposition of the second Jones matrix to produce a unitary part of the second Jones matrix. The method can include extracting an overall phase of the unitary part of the second Jones matrix. The method can include multiplying a target polarization behavior by the overall phase of the unitary part of the second Jones matrix to produce an output. The method can include implementing an inverse Fourier transform of the output to produce a third Jones matrix. The method can include implementing a polar decomposition of the third Jones matrix to produce a unitary part of the third Jones matrix. The method can include iterating one or more of the above steps until a far-field of a metasurface converges to a distribution of Jones matrices that is proportional to the target polarization behavior. The method can include providing the metasurface in which the distribution of Jones matrices and the far-field define a transfer function of the metasurface.

Another aspect of the present disclosure is directed to a method of producing an optical component. The method can include defining a merit figure. The merit figure can include a sum of diffraction efficiencies. The method can include defining a first constraint to achieve a target polarization functionality. The first constraint can include a standard deviation of the diffraction efficiencies with a value of zero. The method can include defining a second constraint to achieve the target polarization functionality. The second constraint can include the cosine of the angle between computed and desired Jones matrices with a value of 1. The method can include providing a metasurface of the optical component based on the merit figure, the first constraint, and the second constraint.

Those skilled in the art will appreciate that the summary is illustrative only and is not intended to be in any way limiting. Other aspects, inventive features, and advantages of the devices and/or processes described herein, as defined solely by the claims, will become apparent in the detailed description set forth herein and taken in conjunction with the accompanying drawings.

### BRIEF DESCRIPTION OF THE DRAWINGS

The details of one or more implementations of the subject matter described in this specification are set forth in the accompanying drawings and the description below. Other features, aspects, and advantages of the subject matter will become apparent from the description, the drawings, and the claims.

FIG. 1A illustrates a Jones matrix hologram implementing a polarization-dependent mask with a far-field, plane wave spectrum polarization response, according to an embodiment.

FIG. 1B illustrates a metasurface including dielectric pillars, according to an embodiment.

FIG. 2 illustrates a Jones matrix phase retrieval, according to an embodiment.

FIG. 3A illustrates a metasurface hologram implementing a far-field in which light is directed on the basis of its incident polarization state, according to an embodiment.

FIG. 3B illustrates a far-field measured on a CMOS sensor for six incident polarization states, according to an embodiment.

FIG. 4A illustrates a response of a polarization-analyzing hologram, according to an embodiment.

FIG. 4B illustrates a polar projection of the northern and southern hemispheres of the Poincare sphere, according to an embodiment.

FIG. 4C illustrates that Jones matrix control can be extended to computer generated holograms (CGHs) with rich features, according to an embodiment.

FIG. 5A illustrates a metasurface whose far-field diffracts light into a circular disk, according to an embodiment.

FIG. 5B illustrates a metasurface illuminated with light of variable input polarization and its far-field viewed through several polarization analyzers, according to an embodiment.

FIG. 5C illustrates a reconstruction of the retardance and fast-axis orientation for a designed metasurface and an experimentally measured metasurface, according to an embodiment.

FIG. 6 illustrates a hologram measurement setup, according to an embodiment.

FIG. 7 illustrates computed far-fields from a waveplate hologram, according to an embodiment.

FIG. 8A illustrates a schematic of a unitary transformation, according to an embodiment.

FIG. 8B illustrates a schematic of a Hermitian transformation, according to an embodiment.

FIG. 8C illustrates the product of a unitary matrix and a Hermitian matrix, according to an embodiment.

FIG. 9A illustrates a metasurface, according to an embodiment.

FIG. 9B illustrates a schematic of single period of a 2D metasurface diffraction grating, according to an embodiment.

FIG. 9C illustrates a schematic of the far-field discrete diffraction orders, according to an embodiment.

FIG. 10A illustrates a measurement and characterization setup, according to an embodiment.

FIG. 10B illustrates a top-view of a fabricated metasurface grating, according to an embodiment.

FIG. 10C illustrates an angular top-view of a metasurface diffraction grating, according to an embodiment.

FIG. 10D illustrates an angular top-view of the edge of a metasurface diffraction grating, according to an embodiment.

FIG. 11 illustrates far-field results of a 2D metasurface diffraction grating with varying diattenuation, according to an embodiment.

FIG. 12 illustrates far-field results of a 2D metasurface diffraction grating with varying retardance-axes, according to an embodiment.

FIG. 13 illustrates far-field results of a 2D metasurface diffraction grating with varying diattenuation and retardances properties, according to an embodiment.

FIG. 14A illustrates a histogram of the measured diattenuation, according to an embodiment.

FIG. 14B illustrates a histogram of the measured retardance, according to an embodiment.

FIG. 14C illustrates a histogram of the measured depolarization index, according to an embodiment.

FIG. 15 illustrates far-field results of a 2D metasurface diffraction grating with varying diattenuation-axes, according to an embodiment.

FIG. 16 illustrates far-field results of a 2D metasurface diffraction grating with varying retardance, according to an embodiment.

Like reference numbers and designations in the various drawings indicate like elements.

### DETAILED DESCRIPTION

Following below are more detailed descriptions of various concepts related to and implementations of methods and apparatuses for (1) computer generated holograms whose far fields possess designer-specified polarization response and (2) generalized polarization transformations with metasurfaces. The various concepts introduced above and discussed in greater detail below may be implemented in any of a number of ways, as the described concepts are not limited to any particular manner of implementation. Examples of specific implementations and applications are provided primarily for illustrative purposes.

Holographic materials and technologies can permit the control of polarization in a spatially-varying fashion. These can include polarization holograms, polarization gratings, a variety of liquid crystal devices, and metasurfaces. Metasurfaces can include subwavelength spaced-arrays of phase shifting elements which may be strongly form-birefringent. A form-birefringent metasurface can include structure elements having one refractive index suspended in a medium with a different refractive index. Metasurfaces are the specific focus and implementation medium of the systems and methods of the present disclosure. However, the generalized viewpoint disclosed can have broader applicability.

In the paraxial regime, a propagator, commonly the Fourier transform, can link the near-field (e.g., an electric field with a phase and/or amplitude distribution created by the hologram) with the far-field (e.g., a desired phase and/or amplitude) distribution some distance many wavelengths (e.g., greater than 10λ, away) away. For example, the far-field can be located, for example, greater than 10λ, away from the metasurface. The near-field can be distinct from the optical near field owed to evanescent waves. A hologram can refer to the physical field-modifying object, rather than a holographic image in the far-field. A hologram can be described by its spatially-varying, complex-valued aperture transmission (or reflection) function t(x, y), a single complex scalar function given by an amplitude and a phase. For normally incident, plane-wave-like light, t(x, y) can be used as a stand-in for the field itself (an assumption that can be relaxed with the convolution theorem). This picture can be generalized to handle polarization by describing the hologram instead by a 2×2 Jones matrix transfer function J(x,y), permitting the analysis of polarization-sensitive holographic media. J(x,y), which can describe the polarization response at each point (x, y), contains four complex numbers, in contrast to the single complex number t(x, y).

In some approaches (e.g., scalar approach), rather than using this Jones matrix description, the response of a metasurface (or other polarization-sensitive holographic element) can be considered separately upon illumination with one of two orthogonal basis polarization states, which can be elliptical in general. An incident plane wave in one of the basis states, after passing through the metasurface, can be designed to create a scalar field that is everywhere uniform in polarization, with a designer-specified overall phase profile. This approach can permit the realization of optical elements (e.g., gratings, lenses, holograms) whose far-field function can switch or be defined on the basis of incident polarization. However, this switchability can be global in nature. One entire far-field response can be ascribed to each polarization state in the chosen basis, and the polarization-dependent response cannot vary over the far field. For all other polarizations, the response can be a weighted superposition of the two. An inherently polarization-dependent problem in this scheme can be reduced to two scalar ones (e.g., imparting two scalar phase profiles).

In some approaches (e.g., vector approach), the metasurface is designed to produce a distribution of polarization ellipses, described by the Jones vector function |j(x, y) [symbol] , so that the far field is given by |α(kₓ, k_{y}) [symbol] = [symbol] {|j(x, y) [symbol] } where [symbol] denotes the Fourier transform operator distributed over both elements of the Jones vector. In this way, the polarization state of the far-field can be made to vary in a desired fashion. However, this approach assumes that the incident light has a particular polarization state. If this changes, so too does the carefully choreographed far-field polarization distribution.

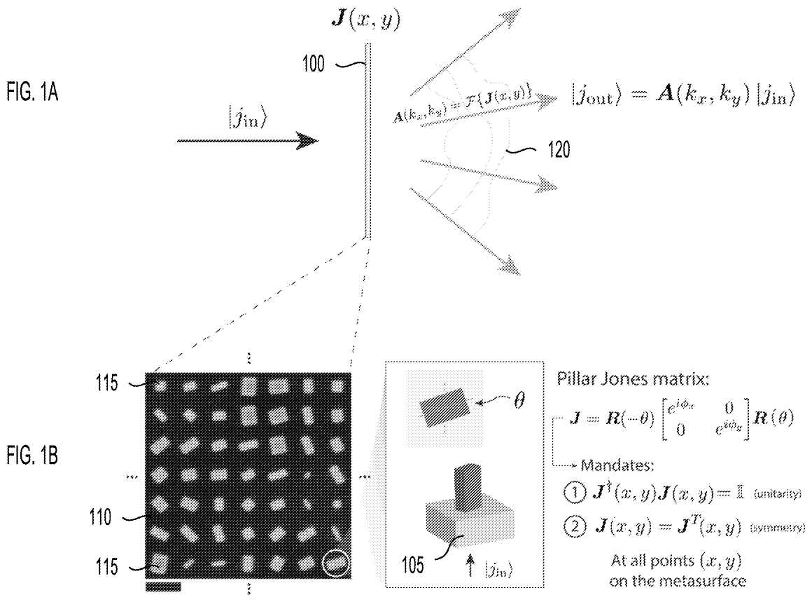

Neither the scalar nor vector approaches recognize the most general polarization-control enabled by the ability to spatially manipulate light's polarization (e.g., with a metasurface). The systems and methods of the present disclosure can use the top-level design of the metasurface as a spatially-varying Jones matrix, specified without regard for any particular incident polarization state. The metasurface can then be described by a spatially-varying Jones matrix J(x,y) and a far-field |A(kₓ, k_{y}) [symbol] = [symbol] {|J(x, y) [symbol] } where the Fourier transform distributes over all four elements (four complex-valued functions) of the Jones matrix. Assuming plane wave incidence, A(kₓ, k_{y})—itself a Jones matrix—can give the polarization-dependent behavior of each plane wave (kₓ, k_{y}) component of the far-field as shown in FIG. 1A. FIG. 1A illustrates a Jones matrix hologram which can implement a polarization-dependent mask (J(x,y)) with a far-field, plane wave spectrum polarization response (A(kₓ, k_{y})) whose behavior can be controlled. FIG. 1A illustrates an optical component 100 and a far-field 120. The far-field response to an incident polarization state with Jones vector |iᵢₙ [symbol] can be found by matrix multiplication.

According to the systems and methods of the present disclosure, rather than trying to control the far-field's intensity for some incident polarization or its polarization state, the polarization transfer function of the far-field is controlled. For instance, if A(kₓ, k_{y}) corresponds to an x polarizer, light can be (e.g., will only be) directed into the plane wave component with direction (kₓ, k_{y}) in a way that depends on the incident polarization state in accordance with a polarizer (e.g., bright if it is |x [symbol] , dark if it is |y [symbol] ).

This matrix approach can encompass the aforementioned vector and scalar ones as subcases: |j(x, y) [symbol] =J(x, y)|η [symbol] is a distribution of polarization states for a chosen incident polarization, |η [symbol] , and [symbol] j(x, y)|κ [symbol] is a scalar field for a chosen analysis polarization state |κ [symbol] .

Now, if a far-field with a polarization-dependent response described by some A(kₓ, k_{y}) is desired, a Jones matrix hologram implementing it is given by inverse Fourier transform as Equation 1 and the J so-obtained and, for that matter, any Jones matrix can be decomposed as Equation 2:

J(x, y)= [symbol] ⁻¹{A(kₓ, k_{y})} (1)

J=HU (2)

where H is a Hermitian (e.g., lossy, polarizer-like) Jones matrix with H^{†}=H and U is a unitary (e.g., lossless, waveplate-like) Jones matrix with U^{†}U= [symbol] ( [symbol] being the 2×2 identity matrix and † the Hermitian conjugate). This can be known as the matrix polar decomposition, derived from the more common singular value decomposition, and is the matrix analogue of the scalar polar decomposition with U playing the role of a phasor and H the role of an amplitude. In general, the near-field J(x,y) corresponding to a desired far-field A(kₓ, k_{y}) by Equation 1 can be (e.g., will only be) neither strictly Hermitian nor unitary.

To extend beyond mathematics into the regime of application, the Jones matrix function J(x,y) may be physically realizable as an optic. For example, this may be accomplished by using metasurfaces including dielectric pillars. These pillars can be everywhere uniform in height (e.g., for ease of fabrication), with cross-sections possessing two perpendicular mirror symmetry axes (e.g., rectangles or ellipses). These metasurfaces can exhibit form-birefringence, implementing a local Jones matrix of the form as shown in Equation 3:

$$J ( x , y ) = R ( - θ ) [ \begin{matrix}{e}^{i {ϕ}_{{x}^{′}}} & 0 \\ 0 & {e}^{i {ϕ}_{{y}^{′}}}\end{matrix} ] R ( θ ) \qquad ( 3 )$$

where ϕₓ′, and ϕ_{y}′, are phases imparted on light polarized along the symmetry axes of the pillar, controlled by varying the elements' transverse dimensions, and 0 is its angular orientation as shown in FIG. 1B.

FIG. 1B illustrates the optical component 100. The optical component 100 can include a substrate 105. The substrate 105 can include glass (e.g., glass wafer). The optical component 100 can include a metasurface 110 disposed on the substrate 105. The metasurface 110 can include one or more linearly birefringent elements 115 (e.g., elements, pillars, dielectric pillars, etc.). The one or more linearly birefringent elements can have linear polarizations. A spatially-varying Jones matrix (e.g., Jones matrix transfer function, Jones matrix function) and the far-field 120 of the metasurface 110 can define a transfer function of the metasurface 110 configured to generate a controlled response (e.g., a response a user can specify or designer-specified) in the far-field according to polarization of light incident on the metasurface 110. The controlled response can include the angular spectrum of an electromagnetic field. The far-field can be defined by a Jones matrix. The far-field can be located at a position greater than 10λ, from a plane containing the metasurface 110. The variable λ can represent a wavelength of the light incident on the metasurface 110. The plane containing the metasurface 110 can include a plane aligned with or coinciding with at least a portion of the metasurface. For example, a plane aligned with or coinciding with at least a portion of the metasurface can include a plane aligned with the bases of the one or more linearly birefringent elements 115. The plane containing the metasurface 110 can include a plane with a normal vector aligned with the one or more linearly birefringent elements 115. The plane containing the metasurface 110 can be parallel to a plane containing the hologram. In some embodiments, the one or more linearly birefringent elements are configured to implement a parallel polarization analysis (e.g., polarization analysis) for a plurality of polarization orders for the light of a target polarization. The polarization analysis can be performed for light of any incident polarization state, independent of any target polarization state. Parallel polarization analysis can include analyzing incident light directed to the far-field 120 in accordance with its projection onto selected (e.g., arbitrarily selected) analyzer polarizations across the far-field 120.

In some embodiments, the metasurface 110 is configured to process the light and direct (e.g., focus, guide, etc.) the processed light with a plurality of polarization states at a plurality of points in the far-field. Processing the light can include modifying the phase profile, amplitude profile, or polarization profile of the light. The metasurface 110 can direct the processed light to specific locations in the far-field, which can correspond to propagation directions. The optical component 100 can direct different polarization states to different and specific points in the far-field.

In some embodiments, the light can have a first polarization state when incident on the metasurface 110. The light can have a second polarization state after processing by the metasurface 110. The metasurface 110 can be configured to process the light and direct the processed light with an arbitrary polarization to specific locations in the far-field. For example, the metasurface 110 can be configured to process the light and direct the processed light with a second polarization state at a point in the far-field. The metasurface 110 can be configured to direct the processed light with a third polarization state at a second point in the far-field. The metasurface 110 can be configured to direct the processed light with a fourth polarization state at a third point in the far-field. This general formulism can be extended to arbitrary polarization states.

In some embodiments, the optical component 100 can include the substrate 105. The optical component 100 can include the metasurface 110 disposed on the substrate 105. The metasurface can include one or more linearly birefringent elements. The metasurface 110 can be configured to implement a target (e.g., arbitrary) polarization transformation (e.g., conversion, modification, etc.) on light incident on the metasurface 110. The target polarization transformation can include a modification of the polarization state of incident light and outgoing light. For example, the polarization state of the incident light can be different from the polarization light. The far-field 120 of the metasurface 110 can include a target polarization response corresponding to the target polarization transformation. The response can include the outgoing light. The metasurface 110 can implement an arbitrary polarization transformation. The far-field 120 of the metasurface 110 can be defined by (e.g., described by) the angular spectrum of an electromagnetic field produced by modification of incident light by the metasurface 110. The angular spectrum can include the amplitude and phase of light.

In some embodiments, a first Jones matrix defines the metasurface 110 and a second Jones matrix defines the far-field 120. For example, the metasurface 110 can be described by a first Jones matrix. The far-field 120 can be described by a second Jones matrix. The first Jones matrix and the second Jones matrix can be different. A Fourier transform of the first Jones matrix can define the second Jones matrix. For example, a Fourier transform can define the mathematical relationship between the metasurface 110 and the far-field 120. The first Jones matrix and the second Jones matrix can be related by a Fourier transform. The far-field 120 can be located at a position greater than 10λ, from a plane containing the metasurface 110. The variable λ can represent a wavelength of the light incident on the metasurface 110.

In some embodiments, the one or more linearly birefringent elements are configured to implement a parallel polarization analysis (e.g., polarization analysis) for a plurality of polarization orders for the light of a target polarization. The polarization analysis can be performed for light of any incident polarization state, independent of any target polarization state.

FIG. 1B illustrates a metasurface including dielectric pillars (e.g., linearly birefringent elements) whose Jones matrices can be subject to certain mathematical constraints. An example SEM (scanning electron micrograph) of a section of a sample is shown. The scale bar represents 500 nm. Equation 3 has just three scalar degrees-of-freedom, while an arbitrary Jones matrix (with its four complex entries) has eight. A pillar-based dielectric metasurface may not implement any desired Jones matrix from point-to-point. Equation 3 instead describes a Jones matrix subject to two key restrictions, those being (1) unitarity, such that J^{†}J= [symbol] and, (2) symmetry, such that J^{T}=J where T denotes a matrix transpose. The former can include a matrix generalization of the statement for scalar light that certain holographic media are phase-only or amplitude-only. The latter can include a way of stating that the eigen-polarizations of Equation 3 may be linear (e.g., no chirality).

These two restrictions imposed by this particular metasurface platform themselves can impose restrictions on the far-field polarization function A(kₓ, k_{y}) achievable with such a metasurface. Any desired far-field function A_{des}(kₓ, k_{y}) of the metasurface may first be compatible with these. The first restriction, matrix symmetry, can be accounted for: J(x,y) can be (e.g., will only be) symmetric if the far-field behavior specified by A(kₓ, k_{y}) is everywhere a symmetric Jones matrix, too, since the matrix Fourier transform linking the two, being essentially an (infinitesimal, exponential-weighted) summation, preserves matrix symmetry. A metasurface whose local Jones matrix is of the form of Equation 3, then, may (e.g., may only) implement polarization behavior in the far-field described by symmetric Jones matrices. Some practical consequences of this rule are elaborated below.

However, in general, even if the system is limited to desired far-field behavior A(kₓ, k_{y}) that is symmetric everywhere, the hologram J(x,y) obtained by Equation 1 may contain both Hermitian and unitary behavior in general, which is incompatible with the second restriction imposed by Equation 3. This issue is less easily addressed. However, progress can be made by recognizing the problem's simpler, scalar analogue: the phase problem.

The phase problem can describe the inverse problem of finding a scalar function that is strictly phase-only which may, nonetheless, have a Fourier transform (e.g., far-field) whose amplitude can be arbitrarily specified (e.g., while its phase is allowed to freely vary).

The phase problem can be one of variational calculus, of finding a functional ϕ(x, y) such that [symbol] {e^{iϕ(x,y)}} is optimum with respect to some function and given constraints. Rather than resorting to a brute-force gradient optimization (which may be numerically impractical over the scale of a large CGH, where the phase at each grid location becomes a free parameter), a number of gradient-free numerical techniques have emerged for diffractive optics. These techniques can include iterative phase retrieval and can be implemented with the Gerchberg-Saxton (GS) algorithm. The GS algorithm can repeatedly switch between the near-fields and far-fields by Fourier transform, keeping the near-field phase and neglecting amplitude variations while retaining the far-field phase and replacing its amplitude with the desired CGH pattern. The GS algorithm can implement gradient descent on the phase function ϕ(x, y), optimizing deviation from a desired far-field intensity pattern in the least-squares sense, without computing a Jacobian for instance.

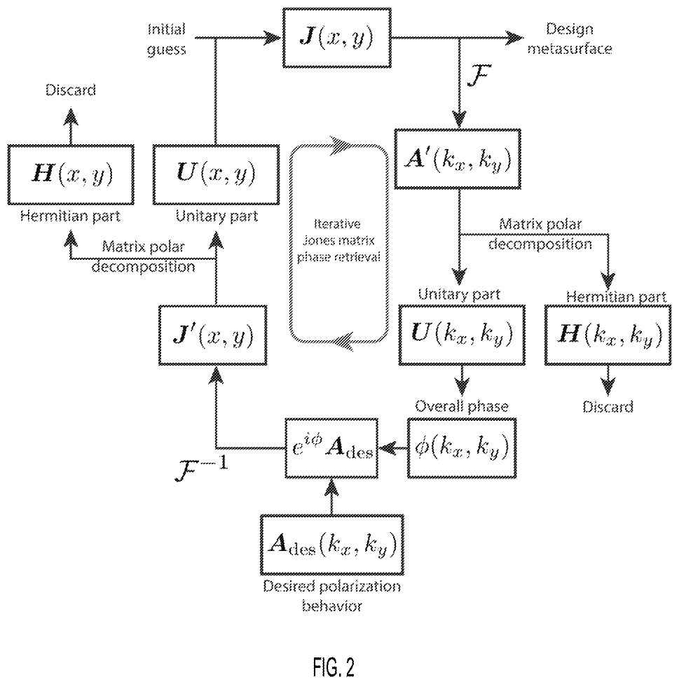

Unitarity can include the matrix analogue of “phase-only”. The scalar GS algorithm can be generalized to operate on matrix quantities using the matrix polar decomposition (for which highly efficient numerical schemes exist) in place of the scalar one. The modified algorithm is shown in FIG. 2. The Gerchberg-Saxton (GS) algorithm can be generalized to allow a unitary Jones matrix mask to implement a far-field whose polarization-dependence A(kₓ, k_{y}) may be arbitrary. Much like the scalar GS algorithm, this matrix generalization can use a division into phase-like (unitary) and amplitude-like (Hermitian) components using the matrix polar decomposition. An initial near-field Jones matrix distribution J(x,y) can be chosen and Fourier transformed, yielding A(kₓ, k_{y}). Its polar decomposition can be found everywhere, and its Hermitian (e.g., lossy) part can be discarded. From the remaining unitary part, an overall phase ϕ can be extracted. This is the overall phase of the matrix, and can be chosen as any element of the Jones matrix (such as the upper left element) so long as this choice is consistently applied. The designer-specified, desired far-field polarization behavior, described by A_{des}(kₓ, k_{y}) can be multiplied by this overall phase distribution φ(kₓ, k_{y}). The resultant quantity can be inverse Fourier transformed to yield J(x, y). After a matrix polar decomposition, the unitary part can be extracted, becoming the new near-field Jones matrix hologram. This cycle can continue iteratively until the far field converges to a distribution of Jones matrices that is, ideally, everywhere proportional to A_{des}(kₓ, k_{y}) up to an overall phase profile φ(kₓ, k_{y}), a free parameter that evolves upon iteration.

The Fourier transform and the matrix polar decomposition can both preserve matrix symmetry. That is, if the desired far-field behavior A_{des}(kₓ, k_{y})=A^{T} (kₓ, k_{y})(kₓ, k_{y}) (and the initial guess for J(x, y) is as well), no asymmetric matrices are introduced into the iterative scheme of FIG. 2. The resultant J(x, y) can, by definition, be of the form of Equation 3 so that, φₓ′, φ_{y}′ and θ can be extracted at each point and a metasurface may designed and fabricated in a dielectric platform of choice. The metasurfaces can be made of TiO₂ pillars for operation at λ=532 nm using a process described herein.

The matrix GS algorithm of FIG. 2 can permit Jones matrix holograms whose far-fields exhibit designer-specified polarization behavior (so long as they obey the above symmetry constraint) to be straightforwardly realized with conventional, pillar-based dielectric metasurfaces. It is a higher-dimensional representation for polarization-dependent metasurface design and is enabled by the matrix polar decomposition.

A method (e.g., iterative phase retrieval method) of producing the optical component 100 can include providing a first Jones matrix. The method can include implementing a Fourier transform of the first Jones matrix to produce a second Jones matrix. The method can include implementing a polar decomposition of the second Jones matrix to produce a unitary part of the second Jones matrix. The method can include extracting an overall phase of the unitary part of the second Jones matrix. The method can include multiplying a target polarization behavior by the overall phase of the unitary part of the second Jones matrix to produce an output. The target polarization behavior can be described by a matrix (e.g., A_{des}(kₓ, k_{y})). The method can include implementing an inverse Fourier transform of the output to produce a third Jones matrix. The method can include implementing a polar decomposition of the third Jones matrix to produce a unitary part of the third Jones matrix. The method can include iterating one or more of the above steps until a far-field of a metasurface converges to a distribution of Jones matrices that is proportional to the target polarization behavior up to an overall phase-profile, ϕ(kₓ, k_{y}). For example, if the far-field of the metasurface does not converge to the distribution of Jones matrices that is proportional to the target polarization behavior, then the method can continue iterating. The method can include providing the metasurface in which the distribution of Jones matrices and the far-field define a transfer function of the metasurface.

The optical component 100 can include can include the substrate 105. The optical component 100 can include the metasurface 110 disposed on the substrate 105. The metasurface 110 can include one or more linearly birefringent elements. A spatially-varying Jones matrix and a far-field of the metasurface can define a transfer function of the metasurface 110 configured to generate a controlled response in the far-field 120 according to polarization of light incident on the metasurface 110.

The optical component 100 can include can include the substrate 105. The optical component 100 can include the metasurface 110 disposed on the substrate 105. The metasurface can include one or more linearly birefringent elements. The metasurface 110 can be configured to implement a target (e.g., arbitrary) polarization transformation on light incident on the metasurface 110. The far-field 120 of the metasurface 110 can include a target polarization response corresponding to the target polarization transformation. The metasurface 110 can implement an arbitrary polarization transformation. The far-field 120 of the metasurface 110 can be defined by the angular spectrum of an electromagnetic field produced by modification of incident light by the metasurface 110.

By the polar decomposition (Equation 2), any Jones matrix can be decomposed into a Hermitian (polarizer-like, amplitude-modulating) and a unitary (waveplate-like, phase-modulating) component. This can provide a categorization of possible experimental test cases. Jones matrix holograms whose far-fields implement both polarizer-like and waveplate-like behaviors can be demonstrated. The examples that follow can be enabled by the Jones matrix approach.

An ideal polarizer can pass its preferred polarization state |λ [symbol] (elliptical in general) without attenuation while extinguishing |λ^{⊥} [symbol] with [symbol] λ|λ^{⊥} [symbol] =0. If this extinction is imperfect, the device is known as a diattenuator. Diattenuators can be described by Hermitian Jones matrices.

Jones matrix holograms whose far-fields implement designer polarizer-like behavior are demonstrated. A conventional polarizer can transmit light at its output whose polarization state matches that being analyzed. A conventional polarizer can be of the form as shown in Equation 4:

A∝|λ [symbol] λ| (4)

The Jones matrix of Equation 4 can be symmetric if λ is a linearly polarization state. The presence of any chirality in the pass polarization λ can destroy the symmetry of the polarizer's Jones matrix and, consequently, its ability to be implemented in the far-field of a conventional pillar-based metasurface Jones matrix hologram. A Jones matrix A∝|λ* [symbol] λ|, where * denotes complex conjugation, can be symmetric, irrespective of whether |λ [symbol] is linear, circular, or elliptical. Such a Jones matrix can match a polarizer's output intensity transfer characteristic, but can differ in that the polarization of exiting light can be of flipped-handedness relative to that being analyzed. This is referred to as a polarization-analyzer, to distinguish from a true polarizer. Demonstrated are devices whose far-fields can be described by the target Jones matrix function as shown in Equation 5:

A_{des}(kₓ, k_{y})=α(kₓ, k_{y})|λ*(kₓ, k_{y}) [symbol] λ(kₓ, k_{y})| (5)

Equation 5 describes a far-field where each point receives light as though a virtual polarizer were placed there. The overall amplitude of light directed there α and the incident polarization λ which evokes maximum intensity can be controlled and may vary arbitrarily from point-to-point.

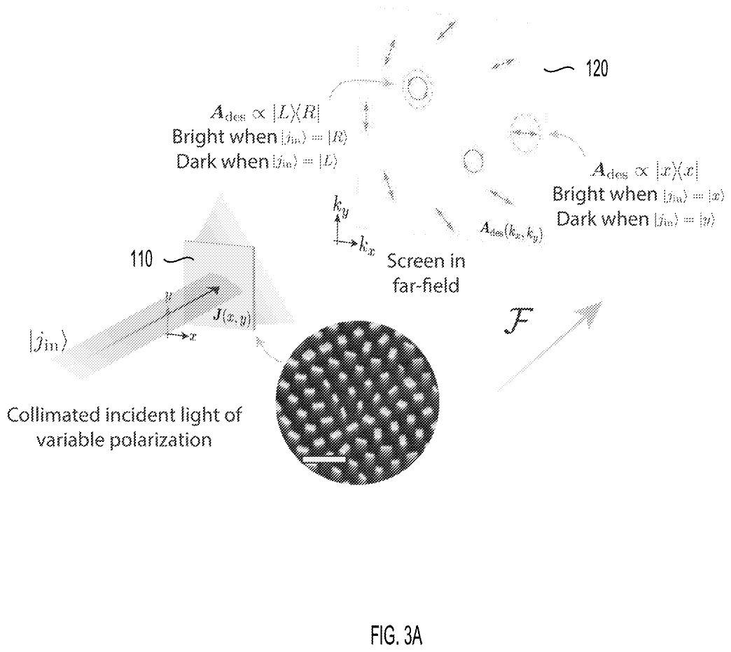

FIGS. 3A and 3B illustrate examples of a polarization-analyzing hologram. Using the methods of the present disclosure (e.g., matrix phase retrieval), a dielectric metasurface 110 can be designed and fabricated based on a given design. In this case, the metasurface 110 can implement a Jones matrix mask J(x, y) whose far-field 120 contains holographic images of different polarization ellipses (eight linear states of varying orientation and both circular polarization states). The region containing each image can act as a polarization analyzer for its respective, depicted polarization state. For example, the holographic image of |x [symbol] (horizontal arrow) is brightest when the incident polarization |j [symbol] ᵢₙ=|x [symbol] and dark when |j [symbol] ᵢₙ=|y [symbol] , as though the pixels contained within the drawing act as an analyzer of |x [symbol] polarized light. The schematic of the far-field 120 shown in FIG. 3A shows all polarization ellipses equally bright. This would be the case in reality if the incident light were perfectly unpolarized, with equal projection onto all polarization states for instance. When illuminated with collimated laser light, a suitably-designed metasurface hologram can implement a far-field in which light is directed on the basis of its incident polarization state. In this example, the hologram is designed to produce a pattern of illustrations of different polarization states. Each drawing acts as an “analyzer” for its depicted polarization state. For instance, the drawing of x-polarized light (horizontal line) is bright when |j [symbol] ᵢₙ=|x [symbol] and dark when |j [symbol] ᵢₙ=|x [symbol] —this part of the far-field implements the Jones matrix A_{des}=|x [symbol] z|. The SEM scale bar is 1 nm. As shown in FIG. 3A, the fabricated metasurface 110 can be illuminated with collimated laser light (e.g., λ=532 nm) of variable polarization. The angular spectrum (e.g., far-field) that results can be imaged onto a CMOS sensor using a relay setup described herein, filtering out the undiffracted zero order along the way. Images can be acquired for many input polarization states (without saturation), permitting a full polarimetric characterization of the grating's response.

FIG. 3B depicts the far-field produced by the metasurface hologram for six incident polarization states, each of which is denoted in the bottom left corner of its image by a label. A scale bar shows the cone angle subtended by the far-field. Each incident polarization state can prompt the strongest response in the region of the hologram corresponding to itself. For example, |j [symbol] ᵢₙ=|145° can prompt the hologram to direct most power to the drawing of diagonal, linearly polarized light, while the image of anti-diagonal polarization is dark with a gradient in-between, while drawings of |x [symbol] , |y [symbol] , |R [symbol] , and |L [symbol] are all about half as bright. When each circular polarization is incident, all linear polarizations can be about equally bright (and half as bright as the image of the incident circular state). The intensity of each polarization depiction can be proportional to the projection of the incident polarization state onto the depicted state in accordance with Malus' Law. The hologram of FIG. 3B is a “visual full-Stokes polarimeter” from which an incident polarization state can be read out by inspection. This behavior would generalize to partial polarization states as well.

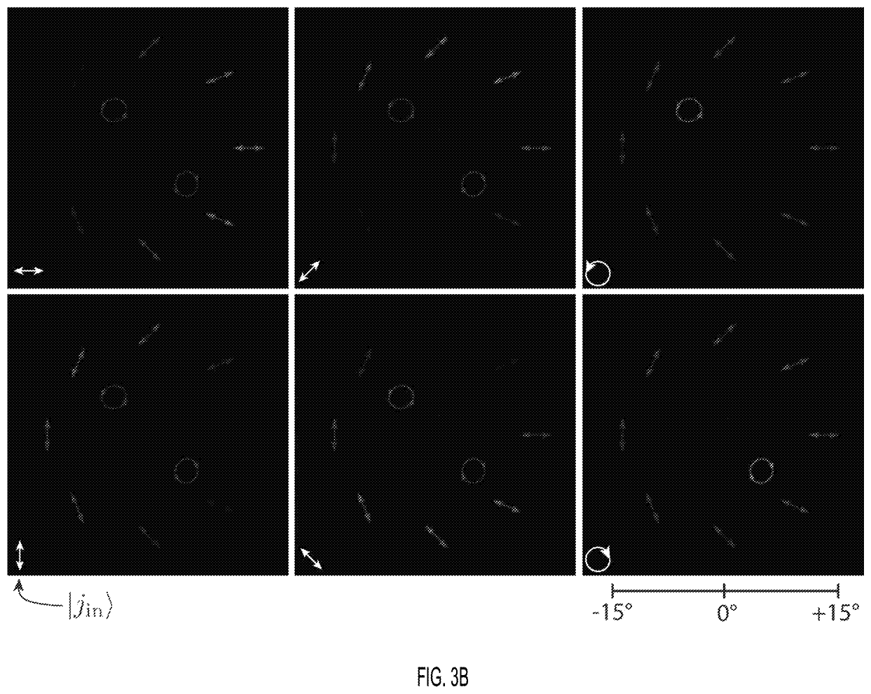

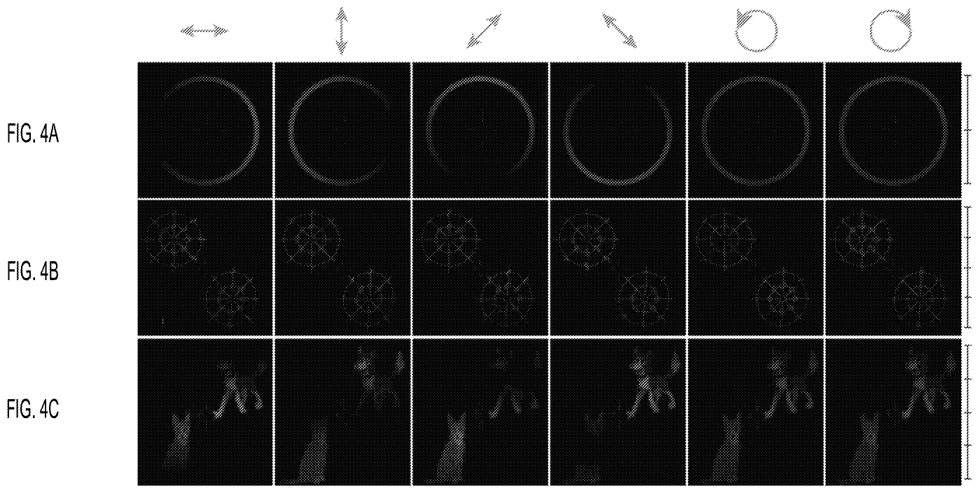

FIGS. 4A-4C illustrate three examples showcasing this design freedom. Three examples are shown of Jones matrix holograms in which incident light is directed to the far-field in accordance with its projection onto arbitrarily selected analyzer polarizations across the far-field. Each column corresponds to an incident polarization (depicted at the top). Scale bars at the right side of each row show the angular bandwidth of the hologram, with each division corresponding to 15° centered about 0°. These holograms can be measured with a polarimetric relay imaging system described herein.

FIG. 4A depicts the response of a polarization-analyzing hologram that is, in some sense, a continuous version of FIG. 3B. Light can be directed into an annular ring with A(kₓ, k_{y}) acting as a linear polarizer that turns with azimuthal angle. The brightest and darkest parts of the ring can rotate with incident linear polarization, remaining 180° apart with Malus' law governing the intensity in-between. For incident circular polarization, the ring can appear equally bright everywhere, with half the power of the maxima observed under linearly-polarized illumination.

FIG. 4B illustrates a more sophisticated version of the hologram of FIG. 3B. FIG. 4B depicts a polar projection of the northern and southern hemispheres of the Poincare sphere. Each drawing of a polarization ellipse can act as an analyzer for its own state. Unlike the example of FIG. 3B, FIG. 4B shows that this approach extends to arbitrary, in-general elliptical polarization states and, moreover, permits features (in particular, the grid lines) that are not sensitive to polarization at all (that is, _{des}∝ [symbol] there) to be mixed with those that are.

The example of FIG. 4C illustrates that Jones matrix control can be extended to computer generated holograms with rich features. Different parts of the image act as polarization analyzers for linear polarization states. The azimuth of these linear polarization states can change smoothly in the vertical direction from |y [symbol] at the bottom, to 145°, |x [symbol] in the middle, to |135° [symbol] and finally |y [symbol] again at the top. Consequently, the image can be uniformly bright (subject to the underlying holographic image) under circularly-polarized illumination. The hologram generated by the metasurface 110 can be uniformly bright. A uniformly bright hologram can include a hologram that has the same brightness across the hologram. In some embodiments, the hologram generated by the metasurface 110 is not uniformly bright. For example, the hologram generated by the metasurface 110 can be distributed in any desired (e.g., target) manner. However, the brightness can distribute in any desired manner. The transfer function of the metasurface can modify an amplitude of the light incident on the metasurface.

In each example in FIGS. 3B and 4A-4C, a scale bar denotes the extent of the image in angle space with each division denoting 15° of cone angle (a length scale may not appropriate, as the hologram expands and contracts depending on the screen's placement). The maximum angular bandwidth over which holographic control can be exerted is dictated by the inter-element separation of the metasurface. An infinity of other similar examples are possible (including with non-unity diattenuation), subject to energy conservation through a modified form of Parseval's Identity. These examples can involve a redirection of light depending on its polarization state. A given location in the far-field of these polarization-analyzing holograms can receive or does not receive incident light depending on its polarization state, akin to the behavior of a polarizer.

This can differ from waveplate-like behavior in which output polarization state, rather than intensity, varies with changing input polarization. Waveplates (e.g., phase retarders) in contrast, can be represented by unitary operators which represent a dephasing of the components of the incident polarization projected onto an orthogonal basis of polarization states with a possible overall phase shift. Demonstrated is a Jones matrix hologram whose far-field implements operators of the form as shown in Equation 6:

$${A}_{des} ( {k}_{x} {k}_{y} ) = {e}^{i \frac{Δ}{2}} \vert λ 〉 〈 λ \vert + {e}^{- i \frac{Δ}{2}} \vert {λ}^{⊥} 〉 〈 {λ}^{⊥} \vert \qquad ( 6 )$$

where Δ is a retardance angle while |λ [symbol] and |λ^{⊥} [symbol] are the eigen-polarizations of the waveplate representing its “fast-axis”. Equation 6 can be used to project incoming light into the eigen-basis and can retard the two components by the angle Δ before reconstructing the output. The retardance and eigen-polarization states can vary across the far-field along with an overall, polarization-independent amplitude. Equation 6 can represent a symmetric Jones matrix, and can be implemented in the far-field of a dielectric metasurface, if the eigen-polarizations |λ [symbol] and |λ^{⊥} [symbol] represent strictly linear polarization states, as is the case with a conventional birefringent waveplate as opposed to a crystal possessing, for example, optical activity.

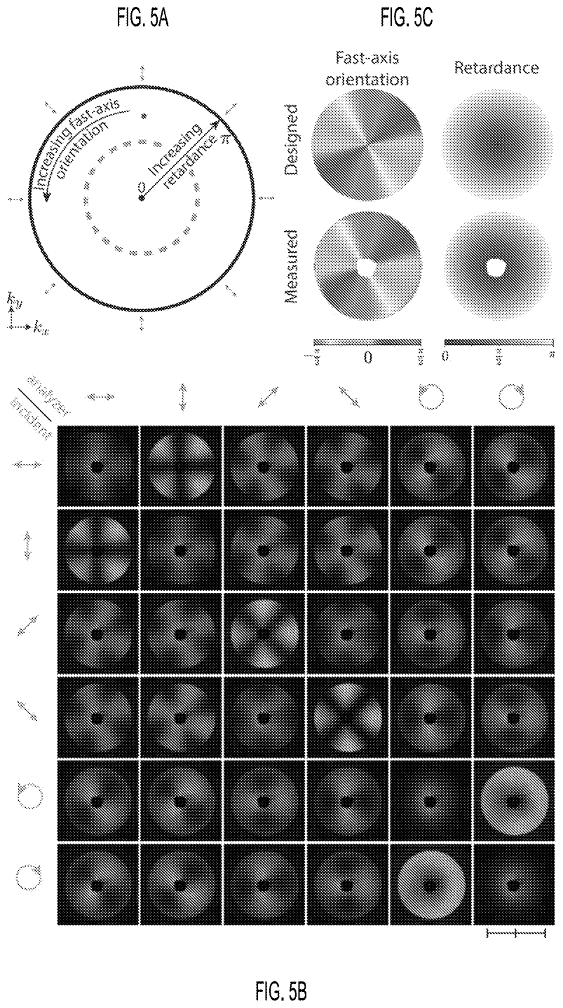

This capability is demonstrated in FIGS. 5A-5C. A metasurface can be designed to diffract light into a disk in the far-field of uniform intensity. FIG. 5A illustrates a metasurface whose far-field diffracts light into a circular disk. Each point in this disk can be designed to implement a Jones matrix A_{des} that acts as a birefringent waveplate. The retardance Δ of this virtual waveplate can increase from 0 to π along the radial coordinate while its fast-axis orientation matches the azimuthal coordinate as denoted by arrows outside the circle. Within this disk all possible linearly birefringent waveplates can be found. For example, the perimeter of the disk can represent all possible half-waveplate operations, while the dotted circle in the center can represent the set of all possible quarter-waveplates. A dot between the dotted circle and the solid circle denotes a 3λ/8 plate oriented at 90° as a specific example. Each point in the disk can be designed to implement a different waveplate operation whose retardance A varies from 0 to π along the radial direction and whose fast-axis direction |λ [symbol] corresponds to the azimuthal coordinate. For example, the outer edge of the disk can include an isoline of all retarders with Δ=π (e.g., the set of all half-wave (λ/2) plates with all possible orientations). The circle halfway between the origin in the edge, denoted by a dotted line in FIG. 5A, can include the set of all quarter-wave (λ/4) plates with Δ=π/2. All other linearly birefringent waveplates can be present. The disk, through a proper parameterization of Equation 6, can contain all linearly birefringent waveplates, at all possible angular orientations, within its extents.

The far-field produced by this waveplate-like hologram does not appear to vary (in an intensity sense) when |j [symbol] ᵢₙ changes. However, the changes can be revealed when the disk is viewed through a polarization analyzer which is also allowed to vary. FIG. 5B shows the patterns produced for six different incident polarization states (e.g., the cardinal polarization states, |x [symbol] , |y [symbol] , |45° [symbol] , |135° [symbol] , |R [symbol] , |L [symbol] )) viewed through six polarization analyzers (a turning linear polarizer paired with a λ/4 plate, for the circular columns). The metasurface can be illuminated with light of variable input polarization (rows) and its far-field can be viewed through several polarization analyzers (columns), producing a diverse array of patterns. An angular scale bar can denote the cone angle subtended by the far-field with 15° divisions. The center of each image can be black because the zero-order has been filtered away. The diverse array of patterns in FIG. 5B can make intuitive sense when the incident polarization is propagated through the desired behavior of the far-field as described in FIG. 5A. For instance, consider the far-field image produced when |45° [symbol] is incident on the metasurface viewed through an |R [symbol] analyzer (second column from right). When diagonally polarized light passes through a quarter-waveplate oriented at 0°, one circular polarization state can be produced. If the quarter-waveplate is oriented at 45°, the opposite handedness can result. This can explain the successive maxima and minima of the images along the quarter-waveplate circle at half the disk's radius, 90° apart.

Each image in FIG. 5B could be similarly intuited. There is, however, a simpler and more direct way of verifying that the far-field behaves in accordance with design. By illuminating the metasurface with a number of different polarization states and viewing these through a number of different polarization analyzers, the 4×4 Mueller matrix describing each point in the far-field can be derived. This Mueller matrix can map the Stokes vector of the polarization state incident on the metasurface to the measured polarization state (e.g., Stokes vector) at each location in the far-field. The Lu-Chipman Decomposition can be applied to each Mueller matrix so that the measured retardance and the fast-axis orientation exhibited by each point in the far-field can be compared to design. This is shown in FIG. 5C, which illustrates a reconstruction of the retardance and fast-axis orientation for a designed metasurface and an experimentally measured metasurface. The experimentally measured metasurface closely matches the designed metasurface. As designed, the retardance exhibited by the waveplates within the far-field disk can increase from 0 to π at its edge. The orientation can rotate smoothly from 0 to π/2 and back again twice around the circle. Due to the twofold angle degeneracy of polarization states, an azimuthal orientation of 3π/2 can be the same as π/2. In the images acquired of the disk, the center can be missing due to undiffracted zero-order light being filtered out in the experimental setup by a physical block.

A description at the level of the Jones calculus can permit the polarization operations enacted by individual elements to be mapped to the polarization transfer function of the far-field. Fourier optics and the Jones calculus can be used as a tool for the design of polarization-sensitive diffractive elements. The methods of the present disclosure provide a unified mathematical framework.

Conventional metasurfaces may enable, for example, lenses that focus in separate locations for x and y polarized light, holograms with independent far-fields for incident circular polarization of opposite handedness, and gratings directing light to either the +1 or −1 order depending on which of two orthogonal polarizations is incident. The polarization basis to which the metasurface is sensitive can be fixed across the far-field. The response to a general incident polarization can be governed by its projection onto these two chosen basis states. Moreover, the ability to enact customizable unitary waveplate-like transformations in the far-field can be a possibility overlooked by conventional systems and methods, which can enable the control of the polarization state of the far-field for a given incident polarization state (e.g., on a set of diffraction orders or over whole holographic images).

However, the systems and methods of the present disclosure show that polarization switchability (e.g., metasurfaces which exhibit separate responses or act as an independent optical element depending on the polarization state of illuminating light) need not be limited to just two polarization states. Rather than ascribing two global responses to one orthogonal polarization basis, the polarization basis can itself change over the extent of the far-field, as in the holograms of FIGS. 3A, 3B, and 4A-4C. The polarization-analyzing behavior exhibited there, as described through the Jones matrix formalism would not have been possible with previous design strategies. Rather than being limited to just two discrete polarization states, the far-field can “switch” on the basis of N. Far-field polarization transformation, rather than just polarization state, may be controlled.

Jones matrix holography, in which a polarization-sensitive mask generates a far-field with customizable polarization response, is described. A treatment based on the Jones calculus enables the design and analysis of these holograms without specification of the incident polarization state. The GS phase retrieval algorithm may be extended to matrix quantities.

The requirement that strictly unitary and symmetric Jones matrix behavior be realized by the far-field could be relaxed with more advanced nanophotonic structures. Metasurfaces composed of two layers of dielectric pillars can break mirror symmetry along the z-direction, allowing for chiral behavior and thus eliminating the restriction of Jones matrix symmetry. Moreover, lossy structures incorporating metals can implement Hermitian behavior that, when paired with other structures, would afford the designer more freedom to create fully general J(x, y) with mixed Hermitian and unitary responses without the use of iterative phase retrieval.

A Jones matrix hologram could add custom polarization-dependence to an optical system's point spread function, either to addresses systematic polarization aberrations in precision imaging systems or to enable wholly new functionality. The systems and methods of the present disclosure can enable elements based on spatially-varying liquid crystals in astrophysical measurements for exoplanet detection. Active photonic platforms can provide a second promising application area. Light distribution in the holograms of the present disclosure can be governed by linearity and Malus' Law. Gain-associated nonlinearities in a laser cavity could potentially surmount this. This could enable polarization-controlled beamsteering if a far-field pattern such as the annular ring of FIG. 4A is used. Beamsteering can include the ability of the metasurface to direct light based on its polarization, even in a continuous fashion.

A step in the design of a Jones matrix hologram can include the definition of Ades(kₓ, k_{y}), the user-specified Jones matrix function that gives the behavior of the plane wave component (kₓ, k_{y}) with respect to incident polarization. A metasurface can be numerically designed to implement this function, and its function may be subsequently verified. experimentally. A_{des} has several restrictions stemming from the metasurface platform itself. The far-field of the hologram is given by [symbol] {J(x,y)} where [symbol] denotes a Fourier transform mapped over all four spatially-varying functions of the 2 x 2 Jones matrix J(x,y) as shown in Equation 7:

$$ℱ \{ J ( x , y ) \} = [ \begin{matrix}ℱ \{ {J}_{11} ( x , y ) \} & ℱ \{ {J}_{12} ( x , y ) \\ ℱ \{ {J}_{21} ( x , y ) & ℱ \{ {J}_{22} ( x , y )\end{matrix} ] \qquad ( 7 )$$

an operation that preserves matrix symmetry. Since a Jones matrix hologram implemented by a metasurface can have a symmetric J everywhere (such that J(x, y)=J^{T}(x, y) everywhere), an Ades that is asymmetric for any (kₓ, k_{y}) may not be permitted. Any generic Jones matrix Q can be broken into its Hermitian and unitary components as shown in Equation 8:

Q=UH (8)

If Q T=Q is required, then H^{T}U^{T}m=UH. Both the unitary and Hermitian components may be themselves symmetric, and moreover they may commute. A generic Hermitian Jones matrix may be written in terms of its eigen-polarization basis as Equation 9 and a generic unitary matrix as Equation 10:

H=p₁|λ [symbol] λ|+p₂|λ^{⊥} [symbol] λ^{⊥}|(S3) (9)

U=e^{iφ1}|λ [symbol] λ|+e^{iφ2}|λ^{⊥} [symbol] λ^{⊥}| (10)

where |λ [symbol] and |λ^{⊥} [symbol] are orthogonal Jones vectors such that [symbol] λ|λ^{⊥} [symbol] =0, p₁ and p₂ are strictly real amplitudes, and φ₁ and φ₂ are phase angles. It can be shown that both H and U are symmetric if and only if their eigen-basis consists of strictly linear polarizations (e.g., with no chirality such that |λ* [symbol] =|λ [symbol] where * denotes complex conjugation). H and U commute if and only if they share an eigen-basis (e.g., |λ [symbol] and |λ^{⊥} [symbol] are the same in Equations 9 and 10).

Polarizer-like behavior was demonstrated. A polarizer Jones matrix P can include a special case of Equation 9 in which one of the two amplitudes p1 or p2 is zero. Then

P=p₁|λ [symbol] λ| (11)

which has a high transmission for the polarization λ while extinguishing its orthogonal counterpart. P^{T}=P, however, only if λ is linear for instance, in some embodiments. A polarizer-like intensity transfer characteristic can still be achieved, however, with a Jones matrix dubbed an analyzer given by Equation 12:

A=p₁|λ* [symbol] λ| (12)

Equation 12 describes a device with a polarization-dependent output intensity equivalent to that of P with the caveat that its output polarization, unlike a traditional polarizer, is a version of the analyzed polarization state with flipped handedness (denoted by *).

The holograms can implement analyzers for their chosen polarizations. This can apply anytime a single-layer metasurface is used to “split” light on the basis of its polarization state. A specific case of this restriction is the reversal of handedness of circular polarization that occurs in geometric phase gratings.

The waveplate-like hologram can implement a far-field A_{des} of a form similar to Equation 4 above without control of overall phase. This can be symmetric if the chosen polarization basis is linear.

A second restriction imposed by the metasurface platform can be unitarity (e.g., that J^{†}(x, y)J(x, y)= [symbol] everywhere where [symbol] is the 2×2 identity matrix). But while the metasurface itself may implement a unitary transformation everywhere, the far-field behavior A_{des} need not be unitary everywhere. The Fourier transform linking the two does may not preserve unitarity. The use of matrix phase retrieval can yield a unitary J(x, y) to implement a desired A_{des}(kₓ, k_{y}). However, by energy conservation, some choices of the function A_{des}(kₓ, k_{y}) are bound to fail.

A unitary device can connote no absorption, so all light in the near-field (e.g., hologram plane) may end up somewhere in the far-field. As a simple example, imagine a desired far-field that only sends light into one direction (k′ₓ, k′_{y}) while analyzing it for |x [symbol] polarized light. That is, A_{des}(kₓ, k_{y})∝|x [symbol] x|δ(kₓ−k′ₓ, k_{y}−k′_{y}) where δ is the Dirac delta function. In the case that |y [symbol] is incident, this would mandate that the far-field receives no light—and therefore has no energy—a contradiction given the unitary nature of J(x, y).

This can be generalized: the total energy content of the hologram's far-field may be equal to that of the near-field. Mathematically, for a given incident polarization with Jones vector |λ, as shown in Equation 13:

∫∫ [symbol] λ|J^{†}J|λ [symbol] dxdy=∫∫ [symbol] λ|A^{†}_{des}A_{des}|λ [symbol] dkₓdk_{y} (13)

where the integral on the left side is taken over the extent of the metasurface hologram while the integral on the right side is taken over the full extent of the far-field (the entire half-space). Equation 13 may be true for any incident polarization, and moreover J is unitary, so that the integral inside the bra-ket may be moved and

∫∫A^{†}_{des}A_{des}dkₓdk_{y}∝ [symbol] (14)

where the integral is taken over the desired far-field and distributes over all four elements of the Jones matrix. Equation 14 can include a Jones matrix generalization of Parseval's theorem. If Equation 14 is grossly violated, as in the x-polarizer example given above, phase retrieval cannot be expected to succeed (e.g., the user desired function A_{des} is not compatible with energy conservation).

The energy-conservation condition Equation 14 is built into the aforementioned examples. The waveplate-like hologram of FIG. 5B can fulfill Equation 14 by default because the waveplate-like A_{des}(kₓ, k_{y}) exhibits an output intensity independent of input polarization everywhere.

In the polarization analyzing holograms of FIGS. 3A, 3B, and 4A-4C, every area that acted as a polarization analyzer can have a counterpart carrying the orthogonal polarization state and maintaining this energy balancing can be automatically satisfied (e.g., equal areas of the hologram analyzed for |λ [symbol] and |λ^{⊥} [symbol] for each polarization chosen, so light lost by one area could be picked up in another). In general, however, this orthogonality constraint can be relaxed while still preserving energy conservation. If the amplitude-weighted average of the analyzers' characteristic polarization states on the Poincare sphere yield the zero vector, Equation 14 may be satisfied.

In practice, the hologram can be implemented using discrete elements on a discrete lattice and designed using discrete Fourier transforms. The hologram J(x, y) and the desired far-field A_{des}(kₓ, k_{y}) can be given by discrete arrays of Jones matrices rather than continuous functions.

Suppose J(x, y) is specified on an N×M lattice with each lattice site having a side length d (e.g., assumed to be the same in both Cartesian directions) so that the hologram has a physical footprint (in length units) of Nd×Md. A(kₓ, k_{y})= [symbol] {J(x, y)} where [symbol] is a discrete Fourier transform (DFT) distributed over the Jones matrix, such that A(kₓ, k_{y}) is also defined on an N×M lattice with each site occupying an (Nd)⁻¹×(Md)⁻¹ box in spatial frequency units. The total angular region occupied by A(kₓ, k_{y}) is a square with a side dimension as shown in Equation 15:

$$θ = 2 arcsin \frac{λ}{2 d} \qquad ( 15 )$$

Thus, the angular region that may be controlled by the hologram can be governed by the operating wavelength λ and the lattice site separation d; N and M only governs the resolution of that control for instance, in some embodiments.

The metasurfaces can include 1000×1000 lattices of pillars separated by d=420 nm, for operation at λ=532 nm. By Equation 15, their far-fields occupy a solid angle spanned by a range of ˜80°, or ±40° in the x and y directions. Outside of this range, the far-field can periodically repeat itself since the hologram is discrete until reaching 90° on either side of center, after which point the plane wave components can become evanescent. At that point the paraxial theory can be used to treat the holograms here may no longer valid.

The desired far-field behavior A_{des}(kx, ky) may be defined on an N×M grid. Moreover, an initial guess for the Jones matrix hologram's mask Jᵢₙᵢₜ(x, y) may be generated. Both Jᵢₙᵢₜ(x, y) and A_{des}(kₓ, k_{y}) may be symmetric everywhere, the former may be unitary, and the latter may be consistent with energy conservation as defined by Equation 14. Both can be defined on 1000×1000 lattices and stored as 1000×1000×2×2 arrays. Jᵢₙᵢₜ(x,y) can be a unitary, symmetric matrix whose three free parameters are generated pseudo-randomly at each sampling location. These can be inputs to the matrix phase retrieval algorithm.

A unitary J(x, y), from which a metasurface can be designed, can be found using a matrix phase retrieval algorithm, depicted in FIG. 2. This is a version of the Gerchberg-Saxton algorithm making use of the matrix polar decomposition to allow operation on matrix quantities. Algorithm 1 provides a different view of the scheme used. The steps detailed in Algorithm 1 can be performed at each discrete site in the hologram.

All Fourier transforms in the algorithm can be implemented by the fast Fourier Transform algorithm with appropriate coordinate shifting. Step 6 of Algorithm 1, isolating the overall phase, can be a particularly important step. φ(kₓ, k_{y}), defined at each lattice point, can include the quantity that evolves upon iteration of the algorithm. The overall phase of the Jones matrix can be arbitrarily isolated by examining the phase of its upper left element. Any of the elements could be used as long as the choice is consistent throughout all iterations.

The matrix polar decomposition may not be cast as a vectorized operation. On a 1000×1000 array, Algorithm 1 thus can be slow. However, this matrix phase retrieval may not require many iterations. In fact, reasonable results are often obtained even after just one iteration.

Algorithm 1

| | | |
|---|---|---|
| 1: | procedure RETRIEVAL | |
| 2: | Inputs: | |
| 3: | Jᵢₙᵢₜ (x, y) | [symbol] Initial guess of hologram Jones matrix distribution |
| 4: | A_{des} (kₓ, k_{y}) | [symbol] Desired far-field polarization behavior |
| 5: | iter | [symbol] Number of iterations |
| 6: | | |
| 7: | | |
| 8: | J(x, y) ← Jᵢₙᵢₜ | [symbol] Initialization |
| 9: | for i = [1, iter] do | |
| 10: | A′(kₓ, k_{y} ) ← [symbol] {J(x, y)} | [symbol] F.T. to far-field |
| 11: | U(kₓ, k_{y}), H(kₓ, k_{y} ) ← polar {A′(kₓ, k_{y})} | [symbol] Far-field matrix polar decomposition |
| 12: | ϕ(kₓ, k_{y}) ← ∠U₁₁(kₓ, k_{y}) | [symbol] Grab overall phase from unitary part |
| 13: | J′(kₓ, k_{y}) ← [symbol] ⁻¹{e^{iϕ(k}^{ₓ}^{, k}^{_{y}}⁾A_{des} (kₓ, k_{y})} | [symbol] I.F.T. to “near-field” |
| 14: | U(x, y), H(x, y ) ← polar {J′(x, y)} | [symbol] “Near-field” polar decomposition |
| 15: | J(x, y) ← U(x, y) | [symbol] Keep only unitary part |
| 16 | return J(x, y) | |

The output of the Jones matrix phase retrieval algorithm, Algorithm 1, can include a spatially-varying Jones matrix J(x, y) which is both unitary and symmetric (e.g., it can be of the form of Equation 3). It can thus be diagonalized and used to find the parameters θ, φₓ, φ_{y}. At each lattice point on the metasurface, a pillar can be selected that best implements these from a library of simulated structures and successfully applied in a variety of other metasurfaces.

The metasurfaces can include arrays of TiO₂ pillars fabricated using a process combining electron beam lithography, atomic layer deposition, and reactive ion etching. The high index and low loss of TiO₂ can enable operation at technologically important visible wavelengths, but the methods of the present disclosure are theoretically wavelength-agnostic, given a suitable material platform at the desired wavelength.

Each hologram can be experimentally characterized using polarimetry. In the case of the analyzer holograms in FIGS. 3A, 3B, and 4A-4C, Stokes polarimetry can be performed, so that a Stokes vector (e.g., the Stokes vector for which a given point analyzes, the polarization to which it is sensitive) is known at every point in the far-field. In the case of the waveplate-like hologram in FIG. 5B, Mueller matrix polarimetry can be performed, so that a 4×4 Mueller matrix M, which maps the Stokes vector of incident polarization on the metasurface to the Stokes vector of output far-field polarization, can be determined for every point in the far-field.

In either case, the far-field produced by the hologram may be imaged under illumination with a set of known incident polarization states. Often, the far field of a computer generated hologram can be imaged upon scattering from a white screen and presented computer generated holograms can be imaged with saturation. However, both concessions may be avoided by the systems and methods of the present disclosure. The intensity of each plane wave component may be recorded directly, not upon scattering, and image saturation may disturb the linearity crucial to polarimetry.

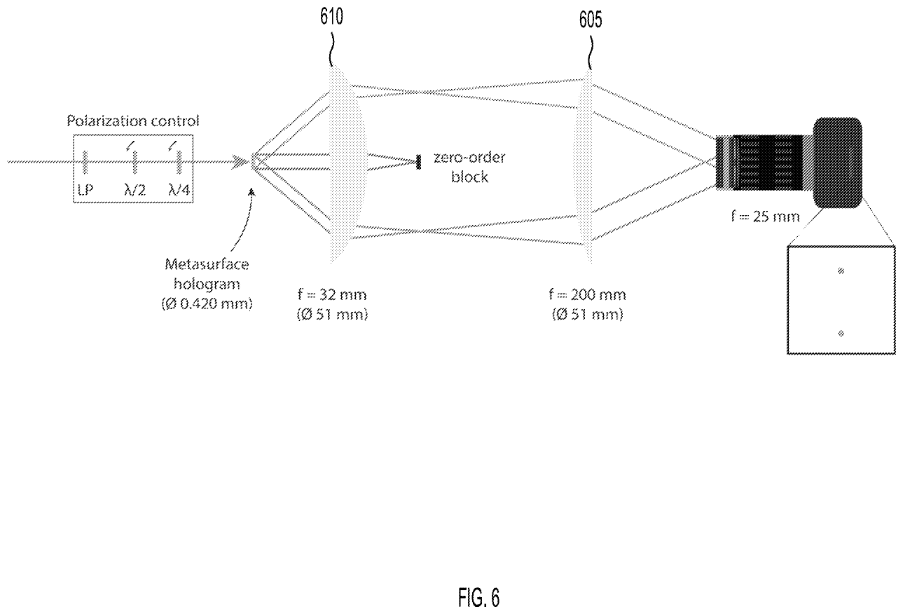

FIG. 6 illustrates a hologram measurement setup. Metasurface holograms can be illuminated by a collimated laser beam (λ=532 nm) whose polarization can be controllably varied by a cascade of a linear polarizer, half-waveplate, and quarter-waveplate (with the waveplates on rotation mounts). The ±40° output plane wave spectrum of the hologram can be captured by an aspheric lens of sufficiently high numerical aperture and demagnified and relayed by a 4f setup, forming a magnified image of the metasurface which is imaged by a final c-mount camera objective to form an image of the hologram's far-field on a CMOS sensor. A physical block can be placed in the Fourier plane of the 4f system to remove zero-order light.

The metasurface can produce a wide angular bandwidth of plane waves (±40°, from Equation 15). An afocal telescope system can demagnify this angular bandwidth, forming a magnified image of the metasurface hologram. A first lens 605 of this telescope can have a sufficiently high numerical aperture to collect the ±40° bandwidth formed by the plane wave spectrum. The afocal telescope system, which can include two lenses, can re-image the metasurface in the focal plane of a second lens 610 with a Fourier plane at the common focal plane in-between the lenses. A physical block can be placed to prevent on-axis, undiffracted zero-order light from propagating.

A camera system focused at infinity can be placed so that its entrance pupil is co-located with the image formed by the telescope. For aberration correction, a compound camera objective (ƒ=25 mm) can be used. However, this can be conveniently abstracted as a singlet lens at the position of the camera lens' entrance pupil, so that the impinging plane waves from the metasurface are focused as points on the camera's CMOS sensor (e.g., the camera sensor is a Fourier plane, conjugate to the telescope's Fourier plane). In this way, the far-field can be imaged by the camera.

The polarization state of laser light incident on the metasurface can be controlled by a fixed linear polarizer and half-waveplate and quarter-waveplate on variable rotation stages. The waveplates can take on a number of configurations. The polarization state produced by the waveplates in each configuration (e.g., its Stokes vector \vec{S}_{inc}) is known, having been measured by a commercial rotating waveplate polarimeter. Suppose there are N such incident polarization states.

For Stokes vector polarimetry (e.g., performed for the analyzer holograms in FIGS. 3B and 4A-4C), the waveplates can visit each configuration, and the far-field of the hologram can be imaged by the camera for each known state.

For Mueller matrix polarimetry (e.g., performed for the waveplate hologram in FIG. 5B), the waveplates can visit each configuration (producing a set of known, incident polarization states) but light passes through a polarization analyzer before entering the camera system. This polarization analyzer can be placed between the final lens of the telescope and the front lens element of the camera objective lens. This analyzer can consist of a polarizer and a removable quarter-waveplate for analyzing circular polarization. Images can be acquired for each known incident polarization state through each of six known analyzer configurations (e.g., |x [symbol] , |y [symbol] , |45° [symbol] , |135° [symbol] , |R [symbol] , and |L [symbol] ).

Using linear algebra, this image data can be used to determine the Stokes vector of the preferred polarization (e.g., analyzer hologram case) or the Mueller matrix (e.g., waveplate hologram case) across the far-field. Suppose the exposure-normalized intensity observed at a given pixel in response to the n^{th} incident polarization state is Iₙ as shown in Equation 16:

Iₙ=½\vec{S}ᵢₙⁿ·\vec{S}₍ₖ_{ₓ}_{, k}_{_{y}}₎ (16)

in other words, that the intensity observed is proportional to the dot product of the incident Stokes vector with the characteristic Stokes vector of the point in the far-field corresponding to the pixel whose intensity-transfer characteristic ideally matches that of A_{des}(kₓ, k_{y}). If the incident polarization matches this characteristic Stokes vector, high intensity can be observed, while if the incident polarization is orthogonal to this characteristic state, the intensity is lowest (though not necessarily zero, depending on the diattenuation of the analyzer's Stokes vector \vec{S}₍ₖ_{ₓ}_{, k}_{_{y}}₎. This characteristic Stokes vector at each pixel can be found.

Equation 16 can be written for all incident polarizations (e.g., all waveplate configurations) simultaneously as Equation 17:

$$\frac{1}{2} [ \begin{matrix}( {\vec{S}}_{in}^{1} ) \\ ( {\vec{S}}_{in}^{2} ) \\ ⋮ \\ {( {\vec{S}}_{in}^{N} )}^{T}\end{matrix} ] {\vec{S}}_{( {k}_{x} , {k}_{y} )} = Λ {\vec{S}}_{( {k}_{x} , {k}_{y} )} = [ \begin{matrix}{I}_{1} \\ {I}_{2} \\ ⋮ \\ {I}_{n}\end{matrix} ] = \vec{I} \qquad ( 17 )$$

The known incident polarization states {\vec{S}ᵢₙ} can be grouped as the rows of the N×4 matrix Λ and a pixel's intensity response to all N incident polarizations can be grouped into the N-dimensional column vector \vec{I}. This matrix equation can be solved in the least-squares sense by applying the left pseudo-inverse to solve for \vec{S}₍ₖ_{ₓ}_{, k}_{_{y}}₎ in the least-squares sense as Equation 18:

\vec{S}₍ₖ_{ₓ}_{, k}_{_{y}}₎=(Λ^{T}Λ)⁻¹Λ^{T}\vec{I} (18)

Twenty-five incident polarization states can be randomly generated by a cascade of a quarter-waveplate and half-waveplate and characterized by a commercial, rotating waveplate full-Stokes polarimeter. Equation 18 can then be solved at each pixel of the image. Raw image acquisitions can undergo a Gaussian blur (11×11 pixels) to mitigate laser speckle and image sensor noise. Knowledge of \vec{S}₍ₖ_{ₓ}_{, k}_{_{y}}₎ everywhere in the image can enable computation of the far-field evoked by any possible incident polarization (having a Stokes vector \vec{S}) by dot product. The response of the far-field to x-, y-, 45°-, 135°-, right-, and left-circularly polarized light could be captured by simply producing just these specific polarization states. However, this more thorough analysis gives other information not readily obtained with a simpler investigation.

The process to determine the Mueller matrix of each location in the far-field is similar, but can use more data (from varying incident polarization states as well as a variable polarization analyzer). Suppose, at a given pixel, the intensity observed for the n^{th} incident polarization state through the m^{th} polarization state is I_{m,n}. It can be given by

I_{m,n}=½\vec{S}_{analyzer}^{m}·M\vec{S}ᵢₙⁿ (19)

where M is the Mueller matrix. Equation 19 can be written in a parallelized, matrix form as Equation 20, which can be shorted to Equation 21

$$[ \begin{matrix}{I}_{1 , 1} & … & {I}_{1 , M} \\ ⋮ & ⋱ & ⋮ \\ {I}_{N , 1} & … & {I}_{N , M}\end{matrix} ] = \frac{1}{2} [ \begin{matrix}{( {\vec{S}}_{anaylzer}^{1} )}^{T} \\ ⋮ \\ {( {\vec{S}}_{analyzer}^{M} )}^{T}\end{matrix} ] M [ \begin{matrix}{\vec{S}}_{in}^{1} & … & {\vec{S}}_{in}^{N}\end{matrix} ] \qquad ( 20 )$$

$$I = \frac{1}{2} AM Λ \qquad ( 21 )$$

where I is a N×M matrix of measured exposure-normalized intensities, A is an M×4 matrix of Stokes vectors describing the polarization analyzers used, M is the 4×4 Mueller matrix to-be-determined, and Λ is a 4×N matrix of incident Stokes vectors. Applying left and right pseudo inverses gives Equation 22:

M=2(A^{T}A)⁻¹A^{T}IΛ^{T}(ΛΛ^{T})⁻¹ (22)

Equation 22 can be simply described. Each incident polarization state can produce an output polarization state at the far-field location under consideration. Its Stokes vector can be found in the least-squares sense by examining its projected intensity onto the set of analyzers. Knowledge of how a set of known input Stokes vectors map onto a now-known set of output Stokes vectors can be sufficient to determine the Mueller matrix transformation in the least-squares sense.

This process can be repeated for every pixel in the far-field image. Once the Mueller matrix is known everywhere, the image that would be observed under a given incident polarization state through a given analyzer can be determined from the data.

Not all 4×4 Mueller matrices are physical. In general, the Mueller matrices derived from experimental data may not obey physicality constraints imposed on Mueller matrix transformations. Each Mueller matrix can be passed through an eigenvalue-like decomposition to, (1) determine if it is a physical Mueller matrix and, if not, (2) to find the closest physical Mueller matrix to the one that is measured.

Each Mueller matrix can be analyzed using the Lu-Chipman Decomposition, a sort-of polar decomposition for Mueller matrices which takes into account depolarization, an effect that may not be describable with the Jones calculus. A retarder Mueller matrix can be extracted from the decomposition, from which the quantities of retardance and the azimuth of the retarder's eigen-axis can be extracted, as shown in FIG. 5C.

Conventional systems can consider each polarization in a single orthogonal eigen-basis separately, assuming that each, upon interacting with the metasurface, creates a field that is everywhere uniform in polarization (same polarization ellipse at each spatial location) but varies in phase. This phase profile evoked by each polarization in the basis can be tailored by adjusting the parameters of linearly birefringent phase shifters. This is trivial for linear polarizations, where it is a propagation-phase-only effect, but it is also possible for circular and elliptical polarization states by a combination of geometric and propagation phase effects. These phase profiles can be designed to implement a specific optical element's phase profile or to yield a far-field amplitude hologram using the traditional, scalar Gerchberg-Saxton algorithm twice (e.g., once for each polarization in the chosen basis).

An assumption that output polarization is uniform over the metasurface's spatial extent does not capture the full richness of possibilities. Moreover its distinction from the approach of the systems and methods of the present disclosure is clear. This uniformity assumption is not made in the present disclosure, and the polarization-response of the far-field does not switch on a whole polarization basis, with the entire far-field being sensitive to just one polarization or another. In the Jones matrix language of the present disclosure, that approach limits the far-field Jones matrix response to the equation shown in Equation 23:

A(kₓ, k_{y})= [symbol] (kₓ, k_{y})|λ* [symbol] λ| [symbol] |λ^{⊥,}* [symbol] λ^{⊥}|. (23)

where [symbol] and [symbol] are scalar responses (e.g., complex-valued responses) ascribed to each polarization in the chosen basis. This may only be a subset of the achievable far-field functionality of the approach described herein, limited to just one polarization basis that does not change across the entire far-field.

In another approach, the response of the metasurface to just one specific incident polarization state is considered, so that a spatially-varying Jones vector is created from a uniformly polarized input as |j(x, y) [symbol] =J(x, y)|jᵢₙ [symbol] . Then, the far-field (also a Jones vector) can be computed by distribution of the Fourier operator over both elements of the Jones matrix |α(kₓ, k_{y}) [symbol] = [symbol] {|j(x, y) [symbol] }. The Gerchberg-Saxton algorithm can find an overall polarization profile (with a specified overall phase) |j(x, y) [symbol] that produces a desired far-field polarization distribution. Metasurface elements can be found at each lattice site such that the necessary |j(x, y)) is produced each point. That approach, however, may assume a specifically chosen input polarization state, making no mention of the metasurface's behavior with polarization in general. As a result, the full freedom of a metasurface to enact a polarization-dependent transfer function in the far-field is not exploited.

Suppose the incident polarization state

$$\vert {j}_{in} 〉 = \vert 45 ° 〉 = \frac{1}{\sqrt{2}} [ \begin{matrix}1 & {1 ]}^{T} .\end{matrix}$$

Then, these vectorial holograms are cases in which the far-field Jones matrix is strictly diagonal, as shown in Equation 24:

$$A ( {k}_{x} , {k}_{y} ) = [ \begin{matrix}{a}_{x} ( {k}_{x} , {k}_{y} ) \sqrt{2} & 0 \\ 0 & {a}_{y} ( {k}_{x} , {k}_{y} ) \sqrt{2}\end{matrix} ] \qquad ( 24 )$$

where αₓ and α_{y} are the x and y components of the desired far-field polarization |α(kₓ, k_{y}) [symbol] =[αₓ(kₓ, k_{y}) α_{y}(kₓ, k_{y})]^{T} such that |α(kₓ, k_{y}) [symbol] =A(kₓ, k_{y})|jᵢₙ [symbol] . In the more general case in which the chosen |Jᵢₙ [symbol] is not |45° [symbol] , the far-field can implement a Jones matrix of the form as shown in Equation 25:

$$A ( {k}_{x} , {k}_{y} ) = R ( - ϕ ) [ \begin{matrix}{a}_{x} ( {k}_{x} , {k}_{y} ) \sqrt{2} & 0 \\ 0 & {a}_{y} ( {k}_{x} , {k}_{y} ) \sqrt{2}\end{matrix} ] R ( ϕ ) \qquad ( 25 )$$

The parameter φ can be dependent on this chosen |jᵢₙ [symbol] , but may not change across the far-field. In other words, in the vectorial approach, the basis which diagonalizes A(kₓ, k_{y}) cannot depend on the far-field coordinates (kₓ, k_{y}).

In contrast, in the present disclosure, no assumptions are made about the nature of the incident polarization state, and no particular restrictions are made on the output polarization state. The device (e.g., optical system, optical component) is instead treated in terms of its transfer function, so that the transfer function of its far-field can also be directly specified and designed. For example, the device can produce holograms whose far-fields implement parallel polarization analysis and custom waveplate-like behavior. A Jones matrix hologram can add custom-polarization dependence to an optical system's point spread function. The device can address systematic polarization aberrations in precision imaging system. The device can use elements based on spatially-varying liquid crystals for astrophysical measurements and exoplanet detection. The device can enable polarization-controlled beamsteering.

The metasurface can be treated in terms of a Jones matrix. However, in conventional methods, generality is lost when the specific input polarization states are assumed (namely, |x [symbol] , |y [symbol] , |45° [symbol] , |135° [symbol] , |R [symbol] , and |L [symbol] ) and the problem is treated in primarily in terms of Jones vectors. The a priori assumption of incident polarization states limits the scheme's generality. Instead, in the present disclosure, the Jones matrix can be treated without regard to any particular incident polarization states, effectively enabling an infinite number of channels.

Moreover, a number of works also attempt to expand the polarization control attainable by metasurfaces by interlacing several such metasurfaces together. In this approach, often dubbed “spatial multiplexing”, “interleaving”, or “shared aperture”, different metasurfaces share the same plane, each designed to implement independent functions. However, since the different metasurfaces share the same spatial aperture, the functions may not be independent. This can result in some tradeoff, depending on exactly how the spatial interlacing is carried out. If the metasurfaces are spatially interlaced, so that individual meta-atoms from one metasurface are adjacent to those from others, this may result in unwanted light loss to diffraction from the “super-cell.” If instead the metasurfaces are interlaced in a way that they occupy different areas, independent functions may only be accessed if different parts of the device are illuminated separately. In contrast, the Jones matrix perspective of the present disclosure shows that multiple functions can be embedded in a single metasurface design and implemented all at once, avoiding these drawbacks and enabling new possibilities.

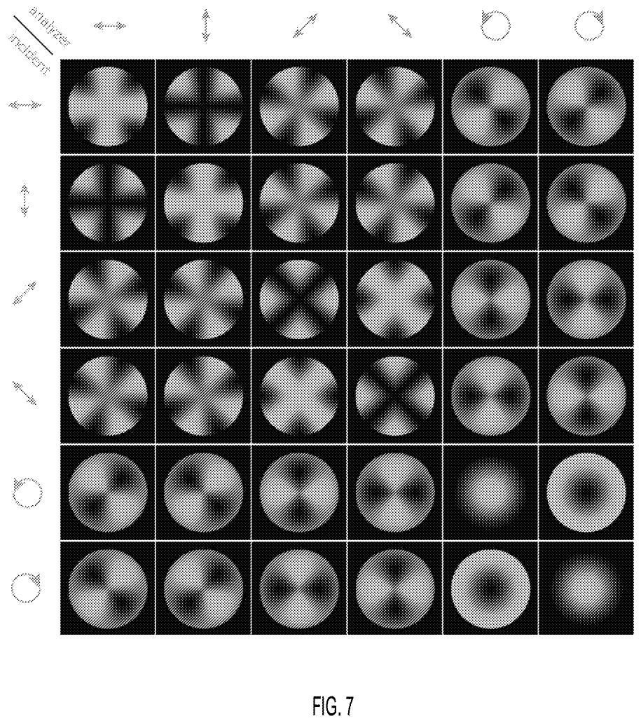

Experimental results are given in FIG. 5B that show a hologram whose far-field implements waveplate-like transformations under various incident polarization states, viewed through several different polarization analyzers, while in FIG. 7, the theoretically expected counterparts to these images are given. FIG. 7 illustrates computed far-fields from a waveplate hologram. FIG. 7 illustrates computed intensity patterns that would ideally be observed for different incident (rows) polarization states when the hologram is viewed through different polarization analyzers (columns). The transfer function of the metasurface can produce a far-field which acts in accordance with a unitary Jones matrix (e.g., lossless, waveplate-like Jones matrix).

Metasurfaces can include arrays of sub-wavelength spaced nanostructures, which can be designed to control the many degrees-of-freedom of light on an unprecedented scale. Meta-gratings can be designed where the diffraction orders can perform general, arbitrarily specified, polarization transformation without any reliance on conventional polarization components, such as waveplates and polarizers. Matrix Fourier optics can be used to design devices and optimized. The designs can be implemented using form-birefringent metasurfaces, and their behavior—retardance and diattenuation can be quantified.

Polarization can include the path of oscillation of light's electric field, which directly follows from the plane-wave solution to Maxwell's Equations. An example from history, of the exploitation of polarization in primitive technology, is that of the use of calcite crystals as ‘sun stones’ by the Vikings back in the seventeenth century, for navigation. In the nineteenth and twentieth centuries, polarization of light, and polarization-based effects were rigorously studied and developed, by many brilliant scientists including Malus (Malus' Law), Brewster (Brewster's angle), Fresnel (Fresnel coefficients), Stokes (Stokes calculus), Maxwell (Maxwell's equations), and Jones (Jones calculus). A thorough understanding, and a robust framework delivered through these efforts in the study of polarization, have since contributed to a myriad of inventions and innovations in science and technology, including in fiber-optic based telecommunications, in astrophysics and astro-imaging, chemical sensing and characterization, medicine, polarization-resolved imaging, quantum light-matter interaction, and quantum information science, to list a few.

Polarization can be manipulated using bulk optics such as polarizers and waveplates. Advances in nanotechnology can provide an opportunity to revisit and reinvent the design space for polarization optics, to achieve unprecedented, wavelength-scale control over the polarization properties of an optical system. A metasurface can include a subwavelength array of artificially engineered nanopillars. Polarization optics involving metasurfaces can include examples such as polarization beam splitters, chiral lenses, polarization generation diffraction gratings, and polarization vectorial holograms. These, and similar works, can assume a particular incident polarization-vector for their designs, which can restrict the design space available for the most general polarization transformations. The systems and methods of the present disclosure can use the matrix Fourier optics formalism, with a gradient descent based optimization, to design the most general polarization (Jones) matrix transformations in the far-field. Using dielectric metasurfaces, two-dimensional diffraction gratings can be implemented that behave as multi-channel polarizing element devices with user-defined polarization properties in chosen diffraction orders. The design principle can be used to design any set of arbitrary polarization transformations in the far-field. The optimized designs can have implementations such as dielectric metasurfaces. The systems and methods of the present disclosure can include the design and implementation of an optical device that has simultaneous and complete control over the polarization transformation properties of resulting diffraction orders in the far-field, of a fully polarized system (e.g., no depolarization). The gap that exists in solutions to problems involving compact and precise polarization control can be bridged, such as the correction of polarization aberrations in optical systems.

Polarized light can be represented as a two-dimensional, vector, commonly known as a Jones vector as shown in Equation 26:

$$\vert j 〉 = {Ae}^{i φ} ( \begin{matrix}1 \\ α {e}^{i Δϕ}\end{matrix} ) \qquad ( 26 )$$

where A is the overall amplitude and φ is the overall phase, of the EM wave, while α and Δ_{ϕ} are the relative amplitude and relative phase respectively, between x-polarized and y-polarized light. α and Δ_{ϕ} can be of more significance in polarization optics, because they fully describe the state of polarization. The Jones vector in an optical system can be transformed—completely—by a 2×2 complex matrix called the Jones matrix, J. In practice, it can be useful to decompose an arbitrary Jones matrix transformation, into a product of two sub-transformations: the ‘retarder’ transformation that transforms the global and relative phases of the Jones vector, and the diattenuator' transformation, that transforms the global and relative amplitudes of the Jones vector. Mathematically, the Jones matrix can be decomposed using the polar decomposition into the product of a unitary matrix U, and a Hermitian matrix H as shown in Equation 27:

J=UH (27)

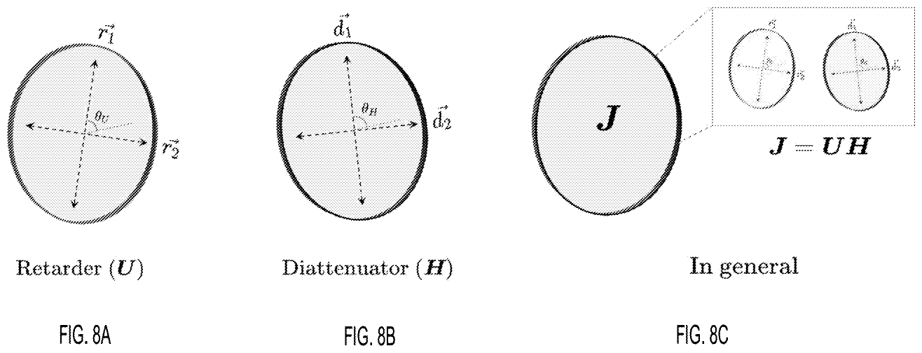

In the context of polarization optics then, U is equivalent to the ‘retarder’ transformation as shown in FIG. 8A, and H is equivalent to the diattenuator' transformation as shown in FIG. 8B. A ‘retarder’, being unitary, has phase-only eignevalues. Phases (ϕ₁, ϕ₂) of the complex eigenvalues (u₁, u₂) of U can be used to define the retardance as Equation 28:

R=|ϕ₁−ϕ₂|, 0°≤R≤180° (28)

The generally complex, and orthogonal eigenvectors (\vec{r}₁, \vec{r}₂) corresponding to the eigenvalues (u₁, u₂) are known as the retardance axes. A light wave polarized along \vec{r}₁ can accumulate R° more phase compared to a light wave polarized along \vec{r}₂. A example of a ‘retarder’ can include a quarter-wave plate (QWP), with R=90°, and eigen-axes parallel to the fast and slow axes of the QWP.

FIG. 8A illustrates a unitary transformation, U, which satisfies U^{†}U= [symbol] , is a lossless transformation. Plane-waves incident along eigenvectors (\vec{r}₁, \vec{r}₂), can accumulate separate phases. Physically, a retarder or a waveplate can perform a unitary Jones matrix transformation. FIG. 8B illustrates a Hermitian transformation, H, satisfies H^{†}=H. Plane-waves incident along eigenvectors (\vec{d}₁, \vec{d}₂), can transmit with different amplitudes. Physical implementation of a Hermitian Jones matrix can b known as a diattenuator or a polarizer. FIG. 8C illustrates the product of a unitary matrix and a Hermitian matrix. In general, any arbitrary 2×2 Jones matrix J can be written as a cascade of a diattenuator (H), followed by a retarder (U).

A ‘diattenuator’, being Hermitian, can have only real eigenvalues. The eigenvalues (t₁, t₂) of H, and the eigenvectors are used to define the diattenutation' property of the polarization transformation. The diattenutation D of a polarization transformation is defined as Equation 29:

$$D = \frac{{\vert {t}_{1} \vert}^{2} - {\vert {t}_{2} \vert}^{2}}{{\vert {t}_{1} \vert}^{2} + {\vert {t}_{2} \vert}^{2}} , 0 \leq D \leq 1 \qquad ( 29 )$$

The generally complex, and orthogonal eigenvectors (\vec{d}₁, \vec{d}₂) corresponding to the eigenvalues (t₁, t₂) are known as the diattenuation axes. t₁ and t₂ are transmission amplitudes for light wave polarized along \vec{d}₁ and \vec{d}₂, respectively. The diattenuation D can indicate the contrast in transmission between polarized light along \vec{d}₁ and \vec{d}₂. A common example of a diattenutator' can include a linear polarizer, with D=1, and diattenuation-axes parallel to the maximum/minimum transmission axes of the polarizer.

In an optical system, even if the resulting polarization transformation is a mixture of retardance and diattenuation, it can be decomposed into its unitary and Hermitian parts using Equation 27, so that the retardance and diattenuation properties can be studied in isolation as shown in FIGS. 8A-8C. By showing complete control over the retardance and diattenutation properties in the design space of the optimization, devices can be designed and fabricated that can perform the most general polarization transformations allowed by the metasurface platform.

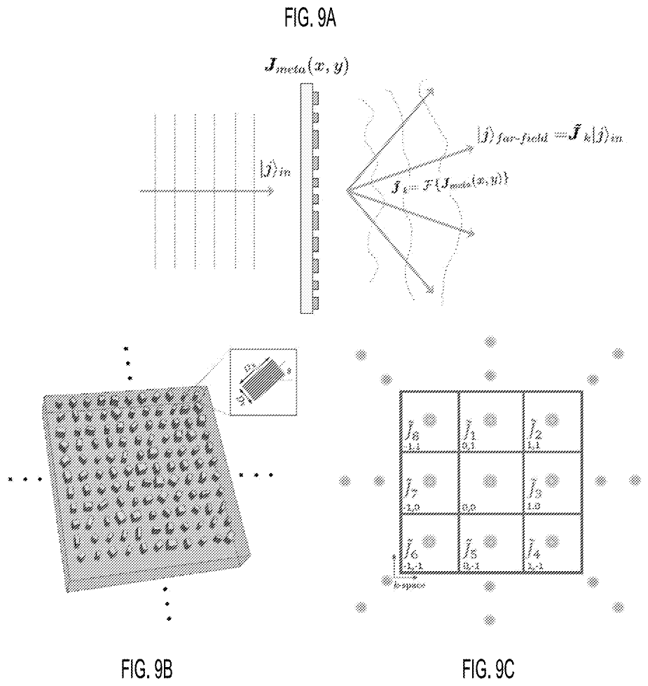

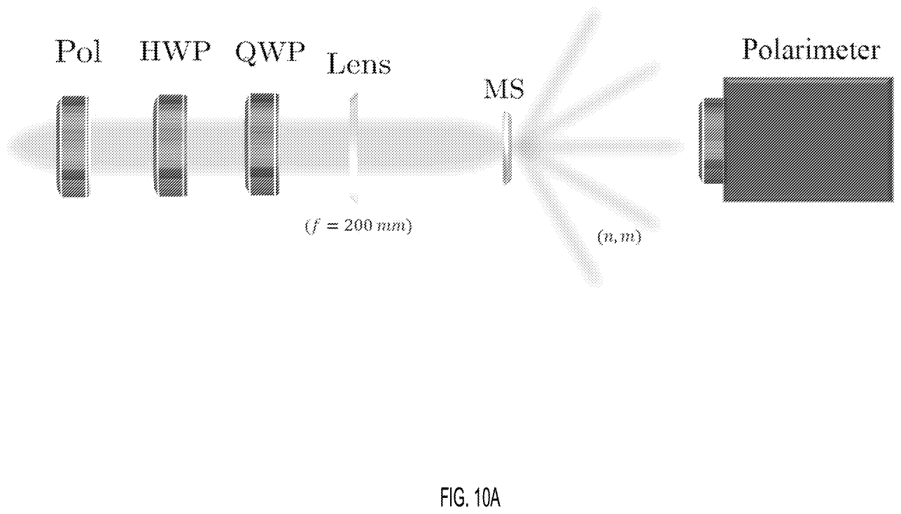

Complete access to the retardance and diattenutation properties, in the far-field, can be enabled by a theory known as ‘Matrix Fourier optics’. It is the matrix generalization—which is allowed due to the linearity of the system—of Fourier optics, that links the ‘near-field’ (ignoring evanescent waves) to the far-field, by a simple Fourier transform, as physically depicted in FIG. 9A. In case of matrices, the coefficients in the Fourier integral are not scalars, but instead are matrices, and the modified Fourier integral can be written as Equation 30:

\tilde{J}(kₓ, k_{y})=∫∫_{-∞}^{+∞}J(x, y)e^{-i()k}^{ₓ}^{x+k}^{_{y}}^{y)}dxdy (30)

where \tilde{J}(kₓ, k_{y}) is a distribution of 2×2 Jones matrices in the far-field over angular coordinates (kₓ, k_{y}), whereas J(x, y) is a distribution of 2×2 Jones matrices in the plane of incidence, over spatial coordinates (x, y). The Fourier integral is distributed across each of the four elements of J(x, y), yielding a matrix Fourier coefficient \tilde{J}(kₓ, k_{y}).

This calculus can enable the setup of an optimization to realize arbitrary polarization transformations in the far-field, as detailed next. Consider a diffraction grating with chosen orders of diffraction with reasonably high efficiencies that performs desired polarization transformations for light diffracted in those orders. To design such a grating, the Matrix Fourier series (Equation 31) can be written, which follows from Equation 30:

$${\tilde{J}}_{meta} ( x , y ) = {\sum }_{\vec{k} ϵ \{ G \}} {\tilde{J}}_{k} {e}^{i ( {k}_{x} x + {k}_{y} y )} \qquad ( 31 )$$

Equation 31 can give a straightforward relation to finding the appropriate spatially varying Jones matrix distribution J (x, y) in the incident plane, to get a set of desired Jones matrices \tilde{J}ₖ in the far-field. However, practically speaking, a constraint may arise when it comes to implementing J (x, y) because metasurfaces, consisting of shape birefringent optical elements, can perform unitary and symmetric transformations at the plane of incidence, of the form as shown in Equation 32:

$${J}_{meta} ( x , y ) = R ( θ ( x , y ) ) ( \begin{matrix}{e}^{i {ϕ}_{X} ( x , y )} & 0 \\ 0 & {e}^{i {ϕ}_{Y} ( x , y )}\end{matrix} ) R ( - θ ( x , y ) ) \qquad ( 32 )$$

where R(θ) is the 2×2 rotation matrix, ϕ_{X} and ϕ_{Y} are the phases imparted on the two orthogonal linear polarizations (X and Y), as incident light propagates through a nanopillar within the metasurface, θ is the orientation of the nanopillar in relation to a reference, and is responsible for introducing geometric phase in the design. In designing a device with far-field Jones matrices \tilde{J}ₖ in orders of interest (\vec{k}ϵ{G}), with reasonably high diffraction efficiencies, while satisfying the form of Jₘₑₜₐ(x, y) in Equation 32 at each spatial coordinate (x, y) in the incident plane, a constrained optimization can be set up and run with respect to a merit figure. The optimization can include the gradient descent optimization, with Lagrange multipliers to handle constraints. ϕ_{X}(x, y), ϕ_{Y}(x, y) and θ(x, y) can each be independently controlled at each spatial coordinate (x, y) within the metasurface, and provide the degrees of freedom to optimize for a particular design.

Consider the design of a two-dimensional diffraction grating where the first eight orders of diffraction {G}={(0, 1), (1, 1), (1, 0), (1, −1), (0, −1), (−1, −1), (−1, 0), (−1, 1), (0, 1)} are chosen to produce desired \tilde{J}ₖ in these diffraction orders, as shown in FIG. 9A. The choice of orders and \tilde{J}ₖ can be arbitrary and designer-specified. To run an optimization to design such a grating using the degrees of freedom ϕ_{X}(x, y), ϕ_{Y}(x, y) and θ(x, y), in conjunction with Equation 31 and Equation 32, the following merit figure to be maximized can be defined as Equation 33:

$$Merit Figure : {\sum }_{\vec{k} ϵ \{ G \}} Tr ( {\tilde{J}}_{k}^{†} {\tilde{J}}_{k} ) \qquad ( 33 )$$

The trace Tr(\tilde{J}ₖ^{†}\tilde{J}ₖ) is simply the sum of the square of amplitudes of the complex entries in \tilde{J}ₖ, and ensures that the optimization maximizes the diffraction efficiency in the set of orders of interest {G}.

To get the desired performance in the far-field, the following two constraints in optimization can be introduced, as shown in Equation 34 and Equation 35:

$$Constraint I : σ ( Tr ( {\tilde{J}}_{k}^{†} {\tilde{J}}_{k} ) ) = 0 \qquad ( 34 )$$

$$Constraint II : {\underbrace{\vert \frac{{\vec{J}}_{k .} {\vec{J}}_{k , des}}{\vert {\vec{J}}_{k} \vert \vert {\vec{J}}_{k , des} \vert} \vert}}_{for all k ∈ \{ G \}} = 1 \qquad ( 35 )$$

In Constraint I (Equation 34), σ operator computes the standard deviation in the computed traces Tr(\tilde{J}ₖ^{†}\tilde{J}ₖ), for all kϵ{G}. The standard deviation can be 0 to ensure that the ‘weights’ of the Jones matrices \tilde{J}ₖ in the desired orders are uniform; physically, one can think of this in terms of the ‘diffraction efficiencies’. Since the response can be polarization dependent, the diffraction efficiency of an order can be defined as the average transmission efficiency of that order for any two orthogonal polarizations. This constraint can allow for the avoidance of the case where one, or more, orders of interest have extremely low efficiencies, because the merit figure (Equation 33) can optimize for the sum total of the efficiencies. The exact diffraction efficiency ratios in Constraint I (Equation 34) can be chosen arbitrarily. Uniform efficiencies is simply one of infinite choices. Constraint II (Equation 35) is the constraint in the optimization which ensures that the Jones matrices \tilde{j}ₖ, during the optimization, converge to the desired forms \tilde{J}_{k,des}, for all kϵ{G}. To fully understand Constraint II (Equation 35), each complex-valued 2×2 Jones matrix \tilde{J}ₖ can be converted into an 8-element vector \vec{j}ₖ:

$${\tilde{J}}_{k} = ( \begin{matrix}{a}_{r} + {ia}_{i} & {b}_{r} + {ib}_{i} \\ {c}_{r} + {ic}_{i} & {d}_{r} + {id}_{i}\end{matrix} ) ⟹ {\vec{J}}_{k} = ( \begin{matrix}{a}_{r} \\ {a}_{i} \\ ⋮ \\ {d}_{r} \\ {d}_{i}\end{matrix} ) \qquad ( 36 )$$

The vector dot product can be used in Constraint II (Equation 35) to ensure that the computed Jones matrices at each iteration, and the desired Jones matrices, are aligned (e.g., have the same form).

The merit figure (Equation 33) can ensure that the overall efficiency of the device is as high as possible, while Constraint I (Equation 34) can ensure that the diffraction efficiencies are uniformly distributed across orders of interest, and Constraint II (Equation 35) can ensure that the Jones matrices in orders of interest are implemented as desired.

Using the design principle and techniques described above, a range of polarization controlling 2D metasurface diffraction gratings can be designed. The design choices can be arbitrary. In practice, these gratings can be designed to suit desired applications in polarization optics.

FIG. 9A illustrates a specially designed metasurface with Jones matrix distribution Jₘₑₜₐ(x, y) which can have plane-wave polarization response Jₖ in the far-field. FIG. 9B illustrates a schematic of a single period of a 2D metasurface diffraction grating made up of discrete form-birefringent nanopillars. Each nanopillar within a period can offer three independent degrees of freedom: propagation phases ϕ_{X} and ϕ_{Y} (controlled by the length D_{X} and width D_{Y}) and geometric phase controlled by the relative angular orientation θ. FIG. 9C illustrates a schematic of the far-field discrete diffraction orders, where the desired orders are engineered to have specific polarization transforming properties. If light is incident on the metasurface with some polarization |j [symbol] ᵢₙ, then the output in order (0, 1) will be \tilde{J}₁|j [symbol] ᵢₙ, in order (1, 1) will be \tilde{J}₂|j [symbol] ᵢₙ and so on.

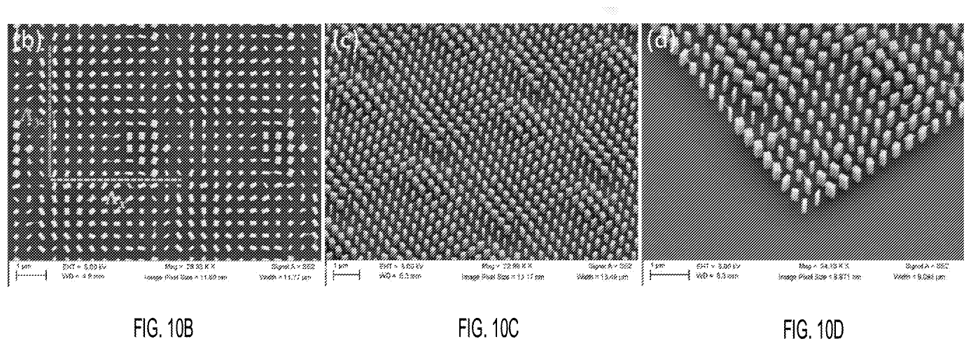

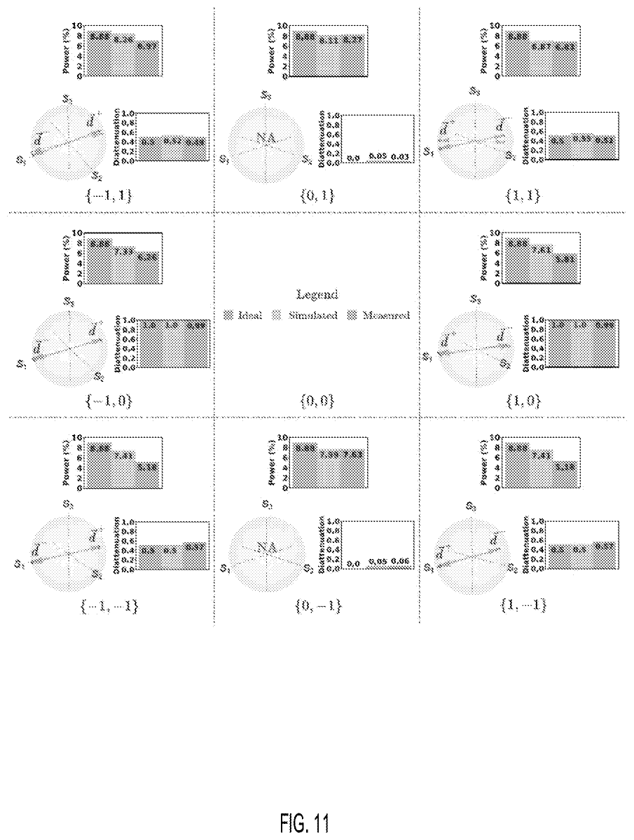

Once the designs are ready and the values of the parameters ϕ_{X}(x, y), ϕ_{Y}(X, y) and θ(x, y) at each lattice point within a period on the metasurface diffraction grating are available (spatial coordinate (x, y) can be discretized as seen in FIG. 9B), the appropriate pillar (planar) dimensions can be selected from a library of simulated pillar results. The device can be prepared for fabrication by first spin coating a fused silica substrate with a positive tone electron beam resist, with the appropriate thickness (pillar height). After baking, the pillar patterns can be written by exposing the resist using electron beam lithography. The developed pattern can define the geometry of the individual nanopillars. Afterwards, TiO₂ can be deposited using atomic layer deposition (ALD), to conformally coat the developed pattern. The excess layer of TiO₂ on top of the device can be etched away by reactive ion etching (RIE). The resist can be removed chemically, leaving the desired TiO₂ nanopillars, on top of the substrate, surrounded by air. The SEM images of one of the fabricated metasurface gratings are shown in FIGS. 10B-10D. FIG. 10B illustrates a top-view of a fabricated metasurface grating. The periods Λₓ and Λ_{y}, in x and y spatial directions respectively, both equal 4.62 μm, consisting of 11 nanopillars in each direction, uniformally spaced by 420 nm. FIG. 10C illustrates an angular top-view of a metasurface diffraction grating, showing sidewalls of the nanopillars. FIG. 10D illustrates an angular top-view of the edge of a metasurface diffraction grating. All nanopillars can have a constant height of 600 nm.

FIG. 10A illustrates a measurement and characterization setup. The incident polarization states can be prepared by using a polarizer, half-wave plate (HWP), and quarter-wave plate (QWP), which are mounted on automated rotational stages. A long focal length lens can be used to reduce the spot size, without introducing any significant higher-k components. The polarized light can be incident on the metasurface sample (MS), and the resulting diffraction orders can be measured one by one, by using a polarimeter mounted on a 3D rotating mount.

The diffraction gratings can be measured and characterized using the setup shown in FIG. 10A. Given that commercial half-wave plates (HWPs) and quarter-wave plate (QWPs), can sometime have a significant error in retardance, and are also sensitive to incidence angle, it can be important to perform the measurements using a calibrated procedure. A calibration can be performed using K pairs of HWP and QWP orientations. K=16 can be sufficient. The polarizations generated by these orientations, which can be chosen to adequately sample the Poincare sphere, can be stored in a calibration matrix as shown in Equation 37:

$$\tilde{C} = ( \begin{matrix}\vert & \vert & … & \vert \\ {\vec{S}}_{1}^{in} & {\vec{S}}_{2}^{in} & … & {\vec{S}}_{k}^{in} \\ \vert & \vert & … & \vert\end{matrix} ) \qquad ( 37 )$$

The K polarizations are then incident on the metasurface, turn-by-turn, and the Stokes vector output on order (n, m) in response to k^{th} input polarization is recorded as \vec{S}ₖ^{(n,m)}, and all these Stokes vectors are stored in the output matrix as shown in Equation 38:

$${\tilde{O}}_{( n , m )} = ( \begin{matrix}\vert & \vert & … & \vert \\ {\vec{S}}_{1}^{( n , m )} & {\vec{S}}_{2}^{( n , m )} & … & {\vec{S}}_{k}^{( n , m )} \\ \vert & \vert & … & \vert\end{matrix} ) \qquad ( 38 )$$

The Mueller matrix \tilde{M}_{(n,m)} associated with diffraction order (n, m) is given by Equation 39 and Equation 40:

\tilde{M}_{(n,m)}\tilde{C}=Õ_{(n,m)} (39)

\tilde{M}_{(n,m)}=Õ_{(n,m)}\tilde{C}^{T}(\tilde{C}\tilde{C}^{T})⁻¹ (40)

Each Mueller matrix is then further post processed, to get the desired polarization properties: to get the retardance and diattenuation properties from a Mueller matrix, the polar decomposition analogue for the Mueller calculus, known as the Lu-Chipman decomposition, can be used, after which the retardance, diattenutation, and their respective eigen-axes can be extracted.

While showing working devices at the visible wavelength using TiO₂ metasurfaces can be important from a technological standpoint, the design principle discussed is wavelength-agnostic, and thus could be useful for any suitable material choice at a desired wavelength. In the metasurface platform, each pillar can do a unitary and symmetric transformation.

Five different 2D metasurface diffraction gratings with different polarization responses in the first eight diffraction orders, {G}={(0, 1), (1, 1), (1, 0), (1, −1), (0, −1), (−1, −1), (−1, 0), (−1, 1), (0, 1)} can be designed, fabricated, and measured. The fabricated metasurfaces can be designed for an incident wavelength λ=532 nm. The results of three out of five gratings can be shown. The designs can be chosen are arbitrary, but they are representative of what can, in general, be achieved in the polarization optics design space, while employing the techniques and technology used.

The results for three of the gratings are shown in FIGS. 11-13. The ideal, simulated, and measured gratings are shown juxtaposed for comparison. The ideal refers to the results of the numeric optimization, in which the designed Jones matrices are accurate to a set tolerance of four decimal places. Thus, the numerical polarization responses could be considered ‘perfect’ from a practical standpoint. This degree of accuracy in polarization response can come at the cost of overall device efficiency. In FIG. 11, each order has an ideal (numerical) diffraction efficiency of 8.88%, which means the overall numerical efficiency of the grating is 8×8.88%≅71%. The rest of the power can be lost to extraneous orders of diffraction, which can afford the optimization the flexibility to meet design targets. The presence of these extraneous orders of diffraction as loss channels can also be understood as a consequence of having more tuning parameters in the design space. In this case, the grating period can consist of 11×11 nanopillars, but increasing the parameter space with the addition of more pillars (pillar separation is fixed at 420 nm), can also increase the period of the grating, resulting in more orders of diffraction available for the light to leak into. The desired polarization responses and relative powers between orders can be achieved, rather than getting a high absolute efficiency. The latter while important, is not a necessary requirement for most polarization optics applications because often one can increase the incident power externally. The simulated responses refer to the results compiled from FDTD simulations, using actual ellipsometry TiO₂ data, and the optimized device dimensions. The measured responses refer to the results compiled following full-Stokes polarimetry of fabricated devices.

FIG. 11 illustrates far-field results of a 2D metasurface diffraction grating with varying diattenuation. FIG. 11 shows the result of a diattenuator-only' grating, where the diattenuation property of the polarization transformation is engineered, in the orders of interest, while avoiding any retardance (in which case the retardance part of the transformation is simply the identity matrix). In this specific design, in the orders of interest {G}, the diattenutation changes from 1 (full-contrast), to 0.5 (partial contrast), to 0 (no contrast), and the diattenuation-axes can be designed such that the maximum transmission axis is aligned along S₁ for half the orders, and is anti-aligned for the other half. Another example of a ‘diattenuator-only’ grating can be seen where we keep the same diattenuation, but change the diattenuation-axes across orders of interest. In this grating, the diattenuation values of the designed Jones matrix responses change across the eight orders of interest, while the diattenuation-axes are designed to be symmetric (e.g., \vec{d}⁺ is aligned along S₁ axis for half the orders, and anti-aligned for the other half). The diattenuation-axes are plotted on the Poincare sphere.

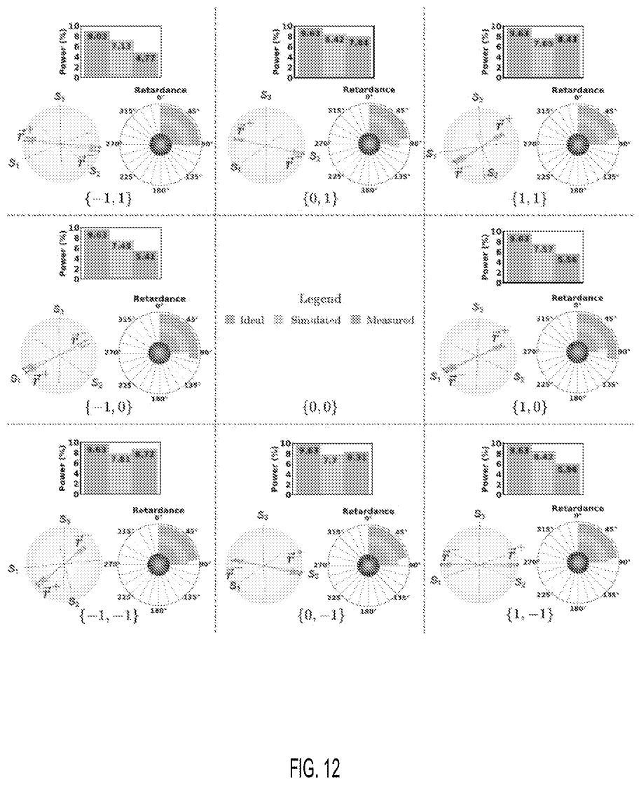

FIG. 12 illustrates far-field results of a 2D metasurface diffraction grating with varying retardance-axes. FIG. 12 shows the results of a ‘retarder-only’ grating, where the retardance property of the polarization transformation is engineered, in the orders of interest, while avoiding any diattenuation (in which case the diattenuation part of the transformation is simply the identity matrix). In this specific design, in the orders of interest {G}, the retardance is kept at a constant of 90° (quarter-wave), while the retardance-axes is designed to rotate along the S₁-S₂ plane of the Poincare sphere, in fixed increments of 45°, when moved from one order in {G} to another. Another example of a ‘retarder-only’ grating can be seen in which the same retardance-axes is kept but the retardance values are changed, across orders of interest. In this grating, the retardance values of the designed Jones matrix responses, are kept the same (R=90°), while the retardance axes are designed to rotate, across the eight orders of interest. The retardance-axes are plotted on the Poincare sphere, and the retardance-axes rotate along the S₁-S₂ plane.

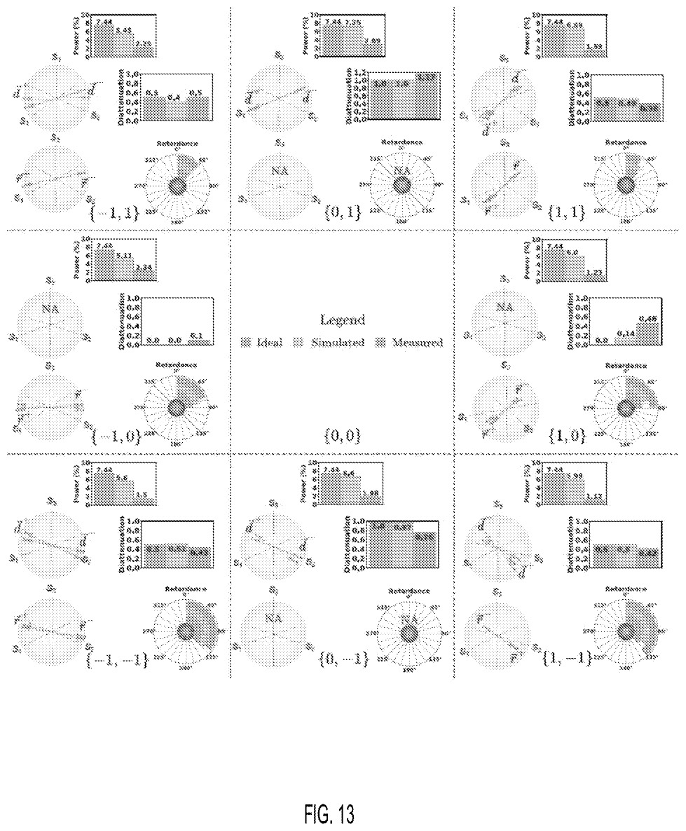

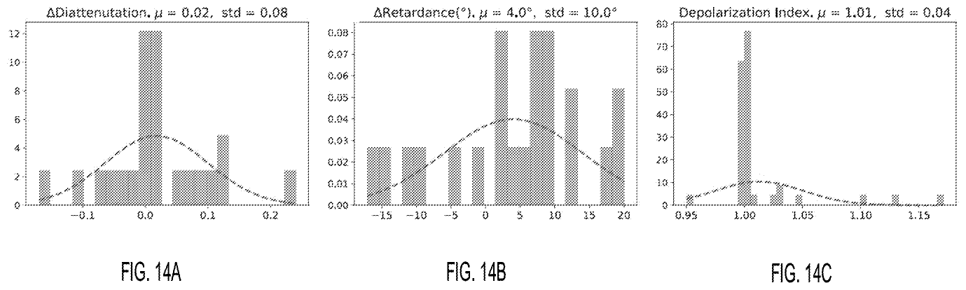

FIG. 13 illustrates far-field results of a 2D metasurface diffraction grating with varying diattenuation and retardances properties. FIG. 13 shows the results of a general polarization grating, in which the diattenuation and retardance properties are simultaneously engineered in orders of interest {G}. When moving from one order to another, the diattenuation, and retardance values, as well as their respective eigen-axes are designed to change arbitrarily, showing the flexibility and versatility of the optimization-enabled design space. In this grating, the diattenuation, the diattenuation-axes, the retardance, and the retardance-axes, can change across orders of interest. The axes are plotted on the Poincare sphere, and the axes rotate along the S₁-S₂ plane.

The results shown FIGS. 11-13 are not snapshot measurements, but are time-averaged. The error bars associated with the time-averaged measurements have not been included, after they were found to be negligible. This is unsurprising, given that the setup was fully automated, and that the commercial polarimeter (ThorLabs model PAX5710VIS-T) measures Stokes components within an accuracy of 0.5%. A more meaningful error metric is the difference between the designed/desired polarization properties, and the ones ultimately measured after fabricating the device, results of which are compiled in FIGS. 14A-14C. Another value to consider is the depolarization index (e.g., the degree of resulting depolarization). The results of which are shown in FIG. 14C. During the data analysis process, the depolarization index can be computed from the Mueller matrix, at each grating order of interest. For a non-depolarizing system, the depolarization index should be 1. Since the laser used is coherent over the length scales of the measurement, and there are no other sources of depolarization in the setup, the system always has a depolarization index of 1, for all diffraction orders. If the measurement setup (including alignment of the polarimeter etc) and analysis is correct, then the computed depolarization index for each diffraction order should be ˜1. Any random or systematic error during measurement, could potentially show up as an artifact of depolarization with a depolarization index 1. As seen in FIG. 14C, the mean depolarization index is well positioned at ˜1.01 with a standard deviation of ˜4%, which shows that the measurements are robust.

FIG. 14A illustrates a histogram of the measured diattenuation. The diattenuations measured across various devices and their diffraction orders show that the standard deviation in the measured diattenuations with respect to the desired diattenuations is ˜8%. FIG. 14B illustrates a histogram of the measured retardance. The retardances measured across various devices and their diffraction orders, show that the standard deviation in the measured retardances with respect to the desired retardances is ˜10°. FIG. 14C illustrates a histogram of the measured depolarization index. The depolarization index, which should ideally be 1 because there is no inherent depolarization in the system, is well poised at a mean μ=1.01 with a standard deviation of ˜4%.

A multi-channel device with simultaneous control over the polarization properties can be designed. The design strategy can implement any conceivable polarization transformation on the diffraction orders, using phase-only structures such as metasurfaces. The optimization scheme can allow for the implementation of any 2×2 Jones matrix.

Other polarization optics, such as quarter/half waveplates and polarizers, may not be able to realize arbitrary Jones matrix transformations. While it is possible to engineer an arbitrary retardance transformation—by either custom-cutting a waveplate to a thickness that corresponds to the desired retardance, or by cascading quarter and half wave plates—it is much harder to engineer an arbitrary diattenuation transformation, using off-the-shelf solutions, such as polarizers and waveplates. A Mach-Zehnder interferometer type configuration with polarization beam splitters, mirrors, polarizers, and waveplates can be used to design an arbitrary diattenuator. However, this solution can be cumbersome compared to the single metasurface device of the present disclosure that can perform, not just one, but a set of arbitrary transformations on multiple orders. The novel way of designing polarization optics as discussed in the present disclosure can help to replace bulky polarizers and waveplates, especially in applications that can utilize compact designs. Furthermore, the finer control over diattenutations and retardances shown here can open up possibilities beyond standard polarization optics.

For example, one area of particular interest is that of polarization aberrations. Polarization aberrations can include deviations from a uniform polarization state expected in an optical system. Parasitic diattenuation and retardance in an optical system can unwittingly transform the expected or desired polarization state within an optical system. This can be undesirable in a number of applications. For instance, the point spread function (PSF) of astronomical telescopes depends not only on geometric aberrations, but also on polarization dependent aberrations introduced by reflection and transmission through various coatings within the optical system. While the polarization aberrations may appear small in scale, the effect is enough to interfere with the detection of large stellar bodies such as exoplanets. Polarization aberrations have also been a problem in polarized-light microscopy, where simultaneously achieving high spatial resolution and contrast is hard because of the presence of these polarization aberrations. Their correction is thus paramount in such optical systems. The flexibility in engineering diattenutation and retardance properties in the present devices, open up a potentially exciting area of research in countering parasitic polarization aberrations in any optical or imaging system, using custom designed metasurfaces.

Each metasurface nanopillar can do a unitary and symmetric transformation of polarization at the incident plane. The far-field matrix distribution can be given by the Fourier transform of the metasurface matrix distribution, made up of arrays of such nanopillars, at the incident plane. A Fourier transform or series can include a sum or summation. A summation of unitary matrices can, in general, result in totally hermitian, or partially hermitian matrices. Diattenutators and analyzers can be designed in the far-field using phase-only (unitary) nanopillar arrays. A sum of symmetric matrices can never result in an asymmetric matrix. The designs can be restricted to symmetric only matrices in the far-field this metasurface platform is used. To better understand the extent of the metasurface polarization optics design space, the following analysis can be performed to derive selection rules for the devices by using Pauli matrices.

A Jones Matrix, most generally, can be written as a sum of Pauli matrices as shown in Equation 41:

J=α(σ₀+α₁σ₁+α₂σ₂+α₃α₃) (41)

where α, α₁, α₂, α₃ are, in general, complex, and the Pauli matrices are defined as:

$${σ}_{0} = ( \begin{matrix}1 & 0 \\ 0 & 1\end{matrix} ) , {σ}_{1} = ( \begin{matrix}0 & 1 \\ 1 & 0\end{matrix} ) , {σ}_{2} = ( \begin{matrix}1 & 0 \\ 0 & - 1\end{matrix} ) , {σ}_{3} = ( \begin{matrix}0 & - 1 \\ i & 0\end{matrix} ) \qquad ( 42 )$$

Furthermore, while describing the evolution of an incident state, through a polarizing system, the acts of retardance and diattenuation, can be described sequentially. For example, in commonplace optics setups, a wave- plate can be followed by a polarizer or vice versa. Therefore, the polar decomposition can be used to describe any Jones matrix as a multiplication of a (Unitary) retarder Jones Matrix, and a (Hermitian) diattenuation Jones matrix. Matrix operations are sequential, and the sequence is particularly important when matrices do not commute. The more right polar decomposition sequence is shown in Equation 43:

J=UH (43)

where U is Unitary and H is Hermitian. Now we can further decompose These two matrices can be further decomposed as a sum of Pauli matrices. The Unitary matrix U can be written as a matrix exponential involving Pauli matrices:

$$U = {e}^{- i \frac{{β}_{0}}{2}} {e}^{- i \frac{\vec{β} . \vec{σ}}{2}} \qquad ( 44 )$$

Here

$$- \frac{{β}_{0}}{2}$$

is the common phase (scalar) which can be ignored from subsequent analysis because its contribution is non-polarizing. Furthermore given β=ββ,−β is the full retardance and \hat{β} is the axis of retardation. Now using the Matrix equivalent of Euler' s identity, Equation 45 can be written:

$$U = {σ}_{0} cos ( \frac{β}{2} ) - i ( \hat{β} . \vec{σ} ) sin ( \frac{β}{2} ) \qquad ( 45 )$$

Here \vec{σ} is a vector of the three Pauli matrices \vec{σ}=σ₁, σ₂, σ₃), where the retarder axis vector \hat{β} can be thought of as a 3-element Stokes vector so \hat{β}=(β₁, β₂, β₃)=(S₁, S₂, S₃). U can be written more explicitly as Equation 46:

$$U = cos ( \frac{β}{2} ) {σ}_{0} - i sin ( \frac{β}{2} ) {β}_{1} {σ}_{1} - i sin ( \frac{β}{2} ) {β}_{2} {σ}_{2} - i sin ( \frac{β}{2} ) {β}_{3} {σ}_{3} \qquad ( 46 )$$

Or, without loss of any polarization properties, Equation 46 can be rewritten as Equation 47:

$$U = {σ}_{0} - i tan ( \frac{β}{2} ) {β}_{1} {σ}_{1} - i tan ( \frac{β}{2} ) {β}_{2} {σ}_{2} - i tan ( \frac{β}{2} ) {β}_{3} {σ}_{3} \qquad ( 47 )$$

Following the analysis for Unitary Matrices, the Hermitian Matrix (Equation 48) can be analyzed:

$$H = {e}^{\frac{{α}_{0}}{2}} {e}^{\frac{\vec{a} . \vec{σ}}{2}} \qquad ( 48 )$$

Ignoring the overall scaling factor

$$H = {σ}_{0} cosh ( \frac{α}{2} ) + ( \hat{α} . \vec{σ} ) sinh ( \frac{α}{2} ) \qquad ( 49 )$$

Equation 48 can be expanded, analogously to the Unitary case as shown in Equation 49:

$${e}^{\frac{{α}_{0}}{2}} ,$$

Without loss of any polarization properties, H can be rewritten as Equation 50:

$$H = {σ}_{0} + ( \hat{α} . \vec{σ} ) tanh ( \frac{α}{2} ) \qquad ( 50 )$$

Note that \vec{α} =α\hat{α} . Further expansion of Equation 50 gives Equation 51 as shown:

$$H = {σ}_{0} - tanh ( \frac{α}{2} ) {α}_{1} {σ}_{1} - tanh ( \frac{α}{2} ) {α}_{2} {σ}_{2} - tanh ( \frac{α}{2} ) {α}_{3} {σ}_{3} \qquad ( 51 )$$

From the equation, the maximum and minimum differential losses are

$$1 \pm tanh ( \frac{α}{2} ) ,$$

with the axis of transmission parallel to a. But since Jones matrices deal with electric fields and not intensities, the expression for these losses can be squared. Using the definition of diattenuation D, involving maximal and minimal intensities, Equation 52 can be written:

$$D = \frac{{( 1 + tanh ( \frac{α}{2} ) )}^{2} - {( 1 - tanh ( \frac{α}{2} ) )}^{2}}{{( 1 + tanh ( \frac{α}{2} ) )}^{2} + {( 1 - tanh ( \frac{α}{2} ) )}^{2}} \qquad ( 52 )$$

Rearranging, α can be written in terms of D as shown in Equation 53:

$$α = 2 {tanh}^{- 1} ⌊ \frac{1 - \sqrt{1 - {D}^{2}}}{D} ⌋ \qquad ( 53 )$$

Where D is constrained to be within 0 and 1. The −\sqrt{1−D²} root can be chosen over the +\sqrt{1−D²}, because the negative root maintains physicality, while the positive root diverges over certain ranges of D.

An arbitrary Jones matrix, starting with its polar decomposed form can be constructed as shown in Equation 54 and Equation 55:

J=UH (54)

J=(σ₀+ir₁σ₁+ir₂σ₂+ir₃σ₃)(σ₀+d₁σ₁+d₂σ₂+d₃σ₃) (55)

The overall phase and scaling can be ignored as they are is non-polarizing. Equation 55 can be multiplied to get the coefficients of Pauli matrices in terms r's and d's. Furthermore, for any symmetric Jones matrix, its σ₃ component needs to be zero (as σ₃ is the only non symmetric Pauli matrix), which provides the necessary and sufficient condition to ensure symmetry. Thus to ensure there is no σ₃ component in the Jones matrix expression, the following relations can be satisfied as shown in Equation 56 and Equation 57:

d₃=r₁d₂−r₂d₁ (56)

r₃₌₀ (57)

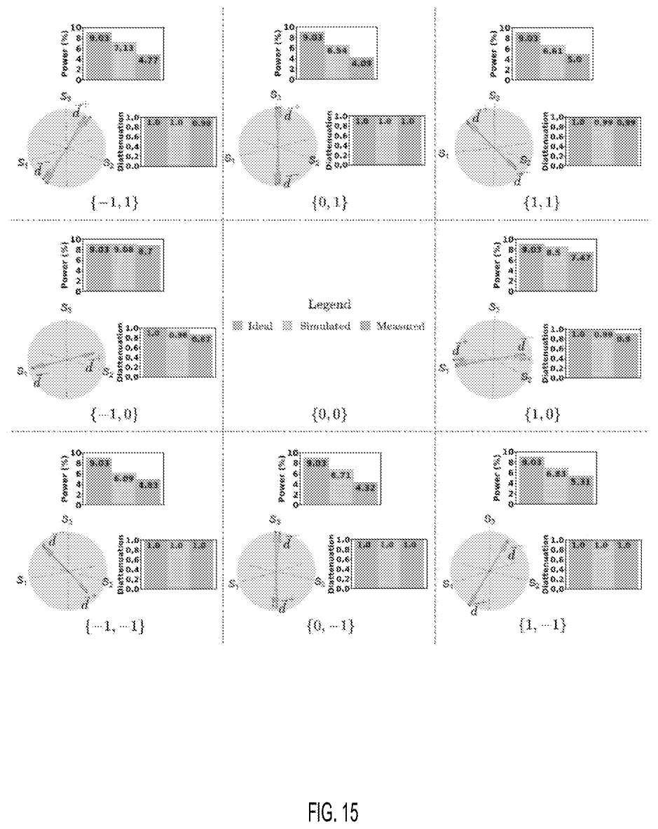

FIG. 15 illustrates far-field results of a 2D metasurface diffraction grating with varying diattenuation-axes. In this grating, the diattenuation values of the designed Jones matrix responses are kept the same (D=1 ‘full’ contrast), across the eight orders of interest, while the diattenuation-axes are designed rotate by fix increments of 45°, from one order to the other. The diattenuation-axes are plotted on the Poincare sphere. The diattenutation-axes rotate along the S₃-S₂ plane.

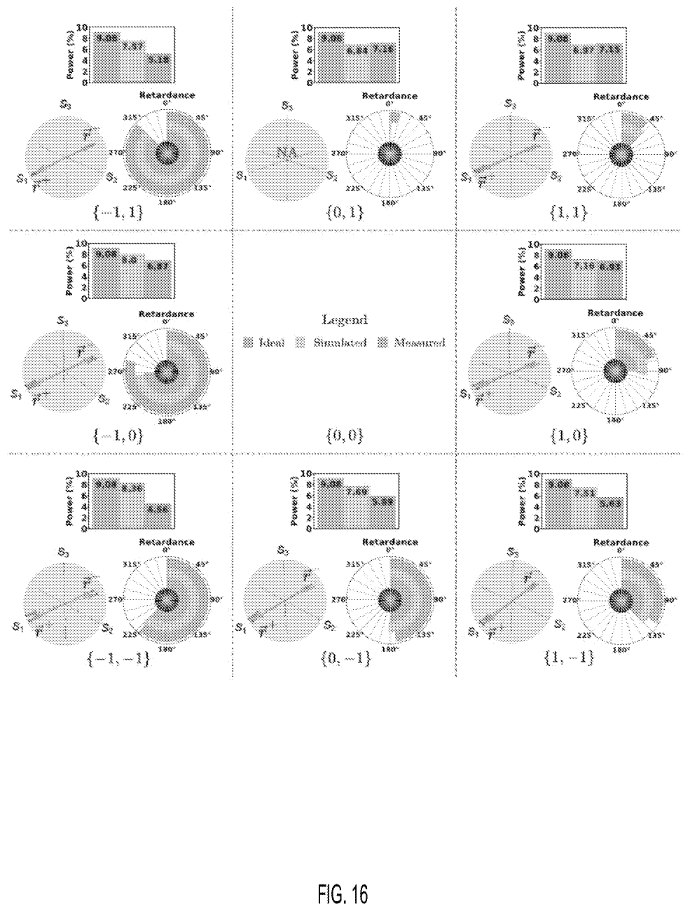

FIG. 16 illustrates far-field results of a 2D metasurface diffraction grating with varying retardance. In this grating, the retardance values of the designed Jones matrix responses, change, across the eight orders of interest, in increments of 45°, while the retardance-axes are designed to be the same (e.g., \vec{r}⁺ is aligned along S₁ axis). The retardance-axes are plotted on the Poincare sphere.

A method of producing the optical component 100 can include defining a merit figure that is the sum of diffraction efficiencies in orders of interest. The diffraction efficiency can include the average transmission efficiency of that order for any two orthogonal polarizations. The merit figure can be used in a gradient descent optimization with Lagrange multipliers to incorporate constraints. For example, the merit figure can be is used in a gradient descent optimization with Lagrange multipliers to incorporate the first constraint (e.g., constraint I) and the second constraint (e.g., constraint II). The merit figure can ensure that the overall efficiency of the device is as high as possible.

The method can include defining a first constraint to achieve a target polarization functionality. The first constraint can include a standard deviation of diffraction efficiencies in orders of interest with a value of zero. The first constraint can include a standard deviation of diffraction efficiencies in orders of interest with a value of zero relative to a desired and/or target diffraction efficiency ratios. The diffraction efficiency of an order can include an average transmission efficiency of that order for any two orthogonal polarizations. The first constraint can ensure that the diffraction efficiencies are uniformly distributed across orders of interest.

The method can include defining a second constraint to achieve the target polarization functionality. The second constraint can ensure a cosine of an angle between computed and desired Jones matrices with a value of is 1. The second constraint can ensure a cosine of an angle between computed and desired Jones matrices is 1. The Jones matrices can be converted to vectors. The second constraint can ensure that the Jones matrices in orders of interest are implemented as desired.

The method can include providing a metasurface of the optical component 100 based on the merit figure, the first constraint, and the second constraint. The optical component 100 can include a substrate. The metasurface can be disposed on the substrate. The metasurface can include one or more linearly birefringent elements.

As used herein, the singular terms “a,” “an,” and “the” may include plural referents unless the context clearly dictates otherwise. Spatial descriptions, such as “above,” “below,” “up,” “left,” “right,” “down,” “top,” “bottom,” “vertical,” “horizontal,” “side,” “higher,” “lower,” “upper,” “over,” “under,” and so forth, are indicated with respect to the orientation shown in the figures unless otherwise specified. It should be understood that the spatial descriptions used herein are for purposes of illustration only, and that practical implementations of the structures described herein can be spatially arranged in any orientation or manner, provided that the merits of embodiments of this disclosure are not deviated by such arrangement.

As used herein, the terms “approximately,” “substantially,” “substantial” and “about” are used to describe and account for small variations. When used in conjunction with an event or circumstance, the terms can refer to instances in which the event or circumstance occurs precisely as well as instances in which the event or circumstance occurs to a close approximation. For example, when used in conjunction with a numerical value, the terms can refer to a range of variation less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, two numerical values can be deemed to be “substantially” the same if a difference between the values is less than or equal to ±10% of an average of the values, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

Additionally, amounts, ratios, and other numerical values are sometimes presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified.

Any references to implementations or elements or acts of the systems and methods herein referred to in the singular can include implementations including a plurality of these elements, and any references in plural to any implementation or element or act herein can include implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation, and references to “an implementation,” “some implementations,” “an alternate implementation,” “various implementations,” “one implementation” or the like are not necessarily mutually exclusive and are intended to indicate that a particular feature, structure, or characteristic described in connection with the implementation may be included in at least one implementation. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Elements other than ‘A’ and ‘B’ can also be included.

The systems and methods described herein may be embodied in other specific forms without departing from the characteristics thereof. The foregoing implementations are illustrative rather than limiting of the described systems and methods.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

The systems and methods described herein may be embodied in other specific forms without departing from the characteristics thereof. The foregoing implementations are illustrative rather than limiting of the described systems and methods. Scope of the systems and methods described herein is thus indicated by the appended claims, rather than the foregoing description, and changes that come within the meaning and range of equivalency of the claims are embraced therein.

While the present disclosure has been described and illustrated with reference to specific embodiments thereof, these descriptions and illustrations do not limit the present disclosure. It should be understood by those skilled in the art that various changes may be made and equivalents may be substituted without departing from the true spirit and scope of the present disclosure as defined by the appended claims. The illustrations may not be necessarily drawn to scale. There may be distinctions between the artistic renditions in the present disclosure and the actual apparatus due to manufacturing processes and tolerances. There may be other embodiments of the present disclosure which are not specifically illustrated. The specification and drawings are to be regarded as illustrative rather than restrictive. Modifications may be made to adapt a particular situation, material, composition of matter, method, or process to the objective, spirit and scope of the present disclosure. All such modifications are intended to be within the scope of the claims appended hereto. While the methods disclosed herein have been described with reference to particular operations performed in a particular order, it will be understood that these operations may be combined, sub-divided, or re-ordered to form an equivalent method without departing from the teachings of the present disclosure. Accordingly, unless specifically indicated herein, the order and grouping of the operations are not limitations of the present disclosure.

1. An optical component, comprising:
a substrate; and
a metasurface disposed on the substrate, the metasurface comprising one or more linearly birefringent elements;
wherein a spatially-varying Jones matrix and a far-field of the metasurface define a transfer function of the metasurface configured to generate a controlled response in the far-field according to polarization of light incident on the metasurface.

2. The optical component of claim 1, wherein the metasurface is configured to process the light and direct the processed light with a plurality of polarization states at a plurality of points in the far-field.

3. The optical component of claim 1, wherein the light has a first polarization state when incident on the metasurface, and has a second polarization state after processing by the metasurface.

4. The optical component of claim 1, wherein the light has a first polarization state and the metasurface is configured to process the light and direct the processed light with a second polarization state at a point in the far-field.

5. The optical component of claim 1, wherein the light has a first polarization state and the metasurface is configured to process the light, direct the processed light with a second polarization state at a first point in the far-field and direct the processed light with a third polarization state at a second point in the far-field.

6. The optical component of claim 1, wherein the light has a first polarization state and the metasurface is configured to process the light, direct the processed light with a second polarization state at a first point in the far-field, direct the processed light with a third polarization state at a second point in the far-field, and direct the processed light with a fourth polarization state at a third point in the far-field.

7. The optical component of claim 1, wherein the far-field is located at a position greater than 10λ, from a plane containing the metasurface, wherein λ represents a wavelength of the light incident on the metasurface.

8. The optical component of claim 1, wherein the controlled response includes an angular spectrum of an electromagnetic field.

9. The optical component of claim 1, wherein the one or more linearly birefringent elements are configured to implement a parallel polarization analysis for a plurality of polarization orders for the light of a target polarization.

10. The optical component of claim 1, wherein a hologram generated by the metasurface is uniformly bright.

11. The optical component of claim 1, wherein the transfer function of the metasurface modifies an amplitude of the light incident on the metasurface.

12. The optical component of claim 1, wherein the transfer function of the metasurface produces the far-field which acts in accordance with a unitary Jones matrix.

13. The optical component of claim 1, wherein the far-field of the metasurface are represented by discrete diffraction orders.

14. The optical component of claim 1, wherein the controlled response comprises a target polarization property.

15. An optical component, comprising:
a substrate; and
a metasurface disposed on the substrate, the metasurface comprising one or more linearly birefringent elements;
wherein the metasurface is configured to implement a target polarization transformation on light incident on the metasurface;
wherein a far-field of the metasurface can include a target polarization response corresponding to the target polarization transformation.

16. The optical component of claim 15,
wherein a first Jones matrix defines the metasurface and a second Jones matrix defines the far-field; and
wherein a Fourier transform of the first Jones matrix defines the second Jones matrix.

17. The optical component of claim 15, wherein the far-field is located at a position greater than 10λ from a plane containing the metasurface, wherein X. represents a wavelength of the light incident on the metasurface.

18. The optical component of claim 15, wherein the far-field of the metasurface is defined by an angular spectrum of an electromagnetic field produced by modification of incident light by the metasurface.

19. The optical component of claim 15, wherein the one or more linearly birefringent elements are configured to implement a parallel polarization analysis for a plurality of polarization orders for light of a target polarization, or
wherein a hologram generated by the metasurface is uniformly bright.

20. (canceled)

21. A method of producing an optical component, comprising:
providing a first Jones matrix;
implementing a Fourier transform of the first Jones matrix to produce a second Jones matrix;
implementing a polar decomposition of the second Jones matrix to produce a unitary part of the second Jones matrix;
extracting an overall phase of the unitary part of the second Jones matrix;
multiplying a target polarization behavior by the overall phase of the unitary part of the second Jones matrix to produce an output;
implementing an inverse Fourier transform of the output to produce a third Jones matrix;
implementing a polar decomposition of the third Jones matrix to produce a unitary part of the third Jones matrix;
iterating one or more of the above steps until a far-field of a metasurface converges to a distribution of Jones matrices that is proportional to the target polarization behavior; and
providing the metasurface of the optical component wherein the distribution of Jones matrices and the far-field define a transfer function of the metasurface.

22-26. (canceled)
